(19) United States
(12) Patent Application Publication
(10) Pub. No.: US 2006/0242694 A1
(43) Pub. Date: Oct. 26, 2006

(54) Mitigation and mitigation management of attacks in networked systems

(76) Inventors: Jeffrey Gold, Lexington, MA (US); Daniel Weber, Matthews, NC (US)

Correspondence Address: FISH & RICHARDSON PC, P.O. BOX 1022, MINNEAPOLIS, MN, 55440-1022, US

(21) Appl. No.: 11/269,169

(22) Filed: Nov. 8, 2005

Related U.S. Application Data
(60) Provisional application No. 60/626,043, filed on Nov. 8, 2004.

(51) Int. Cl. G06G 7/48; G06F 15/16

(52) U.S. Cl. 726/13; 703/8

(57) ABSTRACT

A system includes a plurality of collector devices that are disposed to collect statistical information on packets that are sent between nodes on a network. The system also includes a stackable aggregator that receives network data from the plurality of collector devices, and which produces a connection table that maps each node on the network to a record that stores information about traffic to or from the node. The stackable aggregator includes a manager blade, a database blade, and two or more, analyzer blades.

### CROSS-REFERENCE TO RELATED APPLICATIONS

This application claims priority under 35 U.S.C. §119 to U.S. Provisional Patent Application Ser. No. 60/626,043, filed Nov. 8, 2004, and entitled “Mitigation and Mitigation of Attacks in Networked Systems”, the entire contents of which are hereby incorporated by reference.

### BACKGROUND

This invention relates to techniques to mitigate against attacks detected in computer networks.

Networks allow computers to communicate with each other whether via a public network, e.g., the Internet or private networks. For instance, many enterprises have internal networks (intranets) to handle communication throughout the enterprise. Hosts on these networks can generally have access to both public and private networks.

Managing these networks is increasingly costly, while the business cost of dealing with network problems becomes increasingly high. Managing an enterprise network involves a number of inter-related activities including establishing a topology, establishing policies for the network and monitoring network performance. Another task for managing a network is detecting and dealing with security violations, such as denial of service attacks, worm propagation and so forth.

### SUMMARY

According to an aspect of the invention, a computer program product resides on a computer readable medium for producing recommended mitigation plans to mitigate intrusions in a networked system. The program includes instructions for causing a processor to manage mitigation plans stored in a database and communicate with network devices on the network system to implement and maintain mitigation plans.

Embodiments can include one or more of the following.

The instructions to manage mitigation plans include instructions to manage mitigation related tables in the database. The instructions to manage include a collection of C++ classes that mediate between classes that implement an abstract interface for mitigation devices. The instructions to manage include instructions to analyze events and build a list of hosts that are misbehaving.

The computer program product accesses a do-not-block list that is a collection of hosts and networks expressed as Classless Inter-domain Routing (CIDR) blocks that are too important to be mitigated and thus which are not automatically mitigated. The computer program product accesses a device detail data structure that is a collection of configuration details needed to perform mitigation actions for a specific device. The computer program product access a mitigation actions data structure that is a description of a task to be performed as part of a mitigation plan, including a device and a list of all network nodes that will be directly targeted. The computer program product accesses a mitigation plan data structure that is a collection of actions to be taken, indexed by a non-empty set of network nodes affected by each action. Data associated with active mitigation plans is not modified by any code outside of the mitigation engine.

According to an additional aspect of the invention, a computer program product for an intrusion detection system to produces recommended mitigation plans. The computer program product includes instructions for causing a processor to use unicast routing protocols and unicast reverse path forwarding to provide a route based black hole process to advertise a more specific route for misbehaving hosts associated with its null interface.

Embodiments can include one or more of the following.

Unicast reverse path forwarding causes packets to be dropped if the packets were sent from an affected host, and the packets arrive at a router through an interface other than the interface expected for the traffic. The computer program product causes packets sent to the affected host to be routed to the mitigation host that is configured to send the packets to its null interface where packets are dropped.

According to an additional aspect of the invention, a computer program product resides on a computer readable medium for producing recommended mitigation plans to mitigate intrusions in a networked system. The program includes instructions for causing a processor to disable hosts by turning off a specific port on the switch based on a list of every switch that the user wants to be considered for disabling hosts by turning off a specific port.

Embodiments can include one or more of the following.

The computer program product gathers data from switches in the list. The computer program product includes instructions to gather data from switches in the list. The instructions to gather data from switches in the list include instructions to periodically verify that the device information has not changed.

According to an additional aspect of the invention, a mitigation plan detail interface includes a first section for listing active mitigation plans, which are actions that the user has specifically activated, and a second section for listing inactive mitigation plans, which are actions that the user has decided not to accept.

Embodiments can include one or more of the following.

An action ID (sequence number) appears in the interface so that the user can view the actions in the order of recommendation. The interface includes three columns of information to depict a severity of an ongoing event, a first column is updated dynamically to display current data second column “detection” displays data at the time of detection and “Historical,” which displays historical data pertaining to the host and with each column including a count of host pairs as well as traffic level. The detection column and the historical column are juxtaposed each other to clearly delineate normal behavior and anomalous behavior that caused the event to be triggered. The current column depicts up to date information that changes according to changes in the event, and which will drop to zero if the event is effectively mitigated.

In some additional embodiments, the invention includes a system that includes a plurality of collector devices disposed to collect statistical information on packets sent between nodes on a network and a stackable aggregator device that receives network data from the plurality of collector devices, the aggregator device producing a connection table that maps each node on the network to a record that stores information about traffic to or from the node. The stackable aggregator includes a manager blade, a database blade, and two or more, analyzer blades and wherein each blade includes a mitigation engine to manage mitigation plans stored in a database and to communicate with network devices to implement and maintain mitigation plans.

In some additional embodiments, the invention includes a computer program product for minimizing effects of configuration errors or accidental bad mitigation plans in a intrusion detection system. The computer program product includes instructions to manage mitigation plans in a database, communicate with network devices to implement and maintain mitigation plans, and log all configuration changes to the network devices by a time stamp in order to undo mitigation plan based changes to recover from a configuration error resulting from a mitigation action.

### DESCRIPTION OF DRAWINGS

FIG. 1 is a block diagram of a network including anomaly detection.

FIG. 2 is a block diagram depicting exemplary details of anomaly detection.

FIG. 3 is a block diagram depicting a stackable aggregator.

FIG. 4 is a block diagram depicting a connection table distributed over multiple aggregators.

FIG. 4A is a block diagram of an alternative connection table distributed over multiple aggregators.

FIG. 5 is a block diagram depicting a record in the connection table.

FIG. 6 is a block diagram depicting an arrangement of connection tables distributed over multiple aggregators.

FIG. 7 is a block diagram depicting a stackable aggregator.

FIG. 8 is a block diagram depicting a blade configuration for the stackable aggregator.

FIG. 9 is a block diagram depicting an analyzer blade.

FIG. 10 is a block diagram depicting additional analyzer blades.

FIG. 11 is a flow chart of processes on the aggregator.

FIG. 12 is a flow chart depicting a generalized process for detection of anomalies and classification of events.

FIG. 13 is a flow chart depicting event processing.

FIG. 14 shows process details for a mitigation engine.

FIGS. 15A-15O are screen shots of a user interface for the mitigation engine.

### DETAILED DESCRIPTION

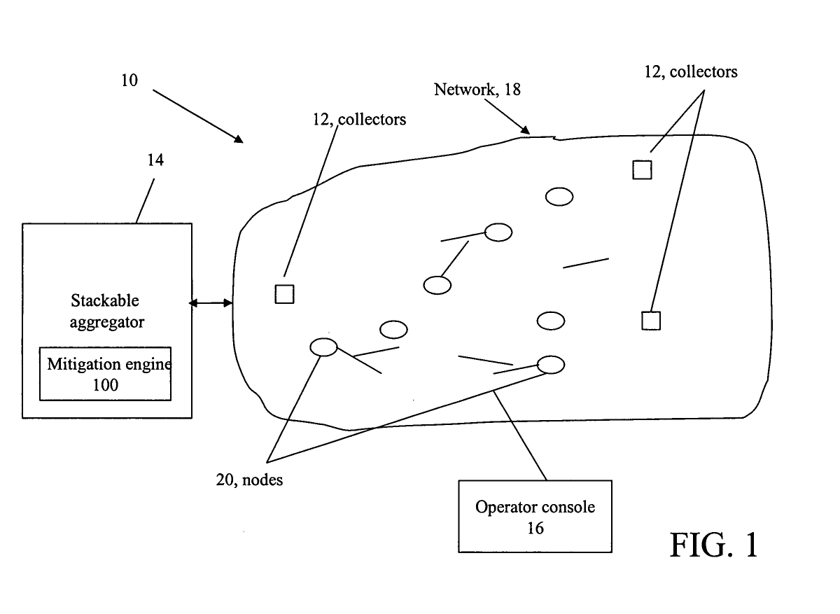

Referring to FIG. 1, an anomaly detection an mitigation system 10 to detect anomalies and process anomalies into events and to suggest or provide mitigation actions is shown. The anomaly detection/mitigation system includes an anomaly detection component and a mitigation component 100.

The anomaly detection system 10 detects denial of service attacks (DoS attacks), unauthorized access attempts, scanning attacks, worm propagation, network failures, and addition of new hosts in a network 18 and so forth. The system 10 includes flow collector devices 12 and at least one stackable aggregator device 14 and an operator console 16 that communicates with and can control collector devices 12 and the stackable aggregator device 14. The flow collector devices 12 and the stackable aggregator 14 are disposed in the network 18. The flow collector devices 12 connect to network devices, 15 e.g., switches, hosts, routers, etc. in line, or via a tap, e.g., using mirror, SPAN ports or other passive link taps.

In some embodiments, the flow collector devices 12 collect information such as source and destination addresses, transport protocol, source and destination ports, flags, and length. The flow collectors 12 periodically send the information to the stackable aggregator 14 allowing the stackable aggregator 14 to store in a connection table, by port and protocol, a record of the number of packets, bytes, and connections between every host pair observed by the flow collector 12. In addition, the flow collector devices 12 send summary information concerning flags seen on TCP packets. The flow collector devices 12 also collect connection information to identify host connection pairs. The stackable aggregator includes a mitigation engine. In some embodiments, each analyzer blade (discussed below) has a mitigation engine, whereas in others a single mitigation engine is responsible for implementing mitigation plans for the entire system. Other arrangements are possible including using a non-stacked aggregator, e.g., having aggregator functionality performed on a single system with a single mitigation engine.

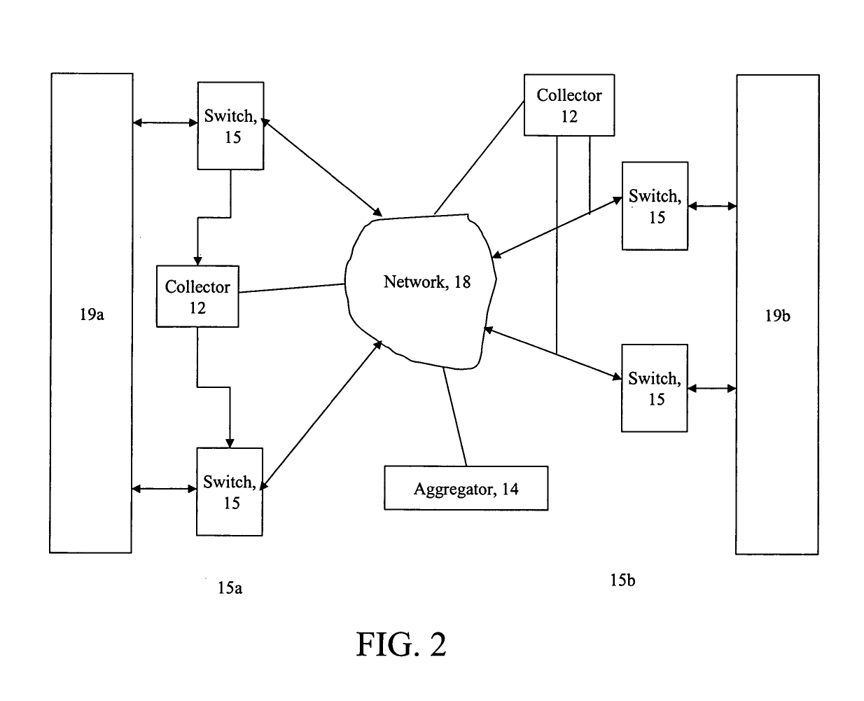

Referring to FIG. 2, flow collector devices 12 are disposed to sample or collect information from network devices 15, e.g., switches, as shown. The flow collector devices 12 send flow data information to the stackable aggregator 14 over the network 18. The flow collectors 12 in one configuration sample all traffic from a downstream network 19a provided that the traffic traverses the switches 15, whereas in another configuration the collectors 12 sample traffic from downstream network 19b that enters and leaves the switches 15.

Flow records are established from flows received from the collectors 12. The flow records represent individual flows, whereas the connection table stores statistical data of bytes/second, packets/second, connections/hour statistics, and so forth over various periods of time, as discussed below allowing comparisons to historical data. The data collectors 12 are devices that are coupled actively or passively on a link and collect the above-mentioned flows. Data collectors 12 are connected via a tap or can span a port on a monitored device (e.g., router, etc.) over intervals of time.

Over such intervals of time, e.g., every 30 seconds, the data collectors 12 send flow records to the stackable aggregator 14. The flow records are sent from the collector to the aggregator over the network being monitored or over a hardened network (not shown). Preferably, the flow records are sent using a reliable protocol such as “Mazu Profiler Control Protocol” “MPCP” or other reliable protocols, e.g., those such as Transmission Control Protocol (TCP) or those built on TCP to insure either delivery of all flow records or indication of missing records.

There are a defined number of sources, a defined number of destinations, and a defined number of protocols on a given network. Over a defined interval (e.g., 30 seconds), the data collectors 12 monitor all connections between all pairs of hosts and destinations using any of the defined protocols. At the end of each interval, these statistics are summarized and reported to the stackable aggregator 14. The values of the collected statistics are reset in the data collectors after reporting.

If more than one collector 12 saw the same source and destination communicating, the following could have occurred. The collectors 12 could be deployed in a way such that only one collector saw the communication, or such that each saw a portion of the communication due to a routing change. Alternatively, the data collectors 12 could be deployed “in series,” such that two or more saw the entire communication. Since route changes occur infrequently (e.g., at long intervals, relative to the length of a flow), the stackable aggregator 14 assumes that different collectors did not each see a portion of the communication. The maximum of two received values is taken as a value for the connection and it is assumed that the lower value reflects dropped packets. Other arrangements are possible.

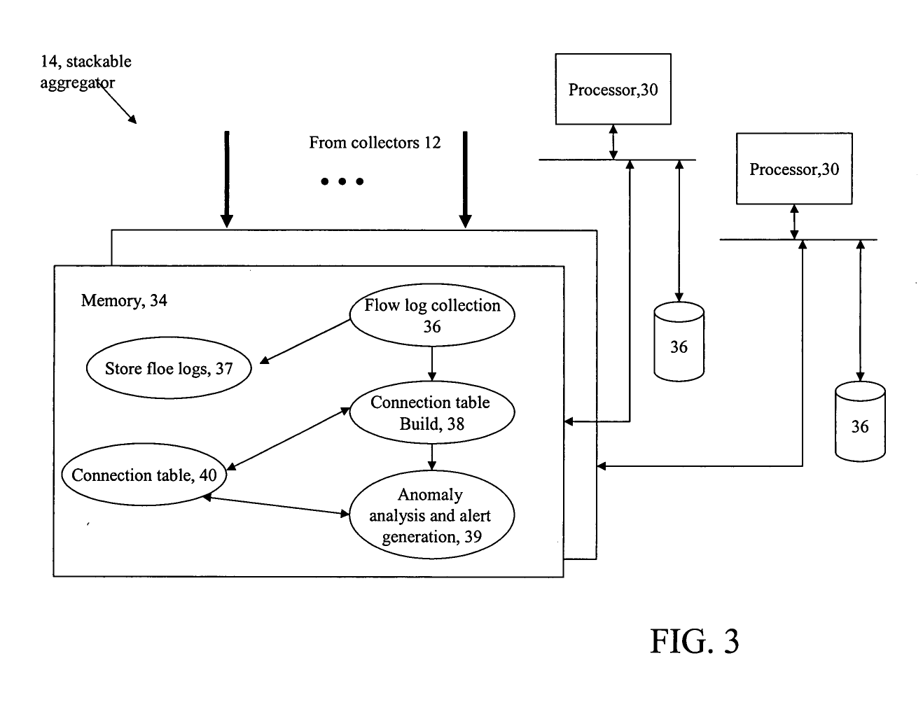

Referring to FIG. 3, the stackable aggregator 14 is a device (a general depiction of a general purpose computing device is shown) that includes at least a pair of processors 30, memory 32 and storage 34. Other implementations such as Application Specific Integrated Circuits are possible. Each unit of the stackable aggregator 14 includes processes 36 to collect flow data from flow collectors 12 or probes 12a, processes 37 to store flow records, and processes 38 to produce a connection table 40 from the flow data or flow records. In addition, the aggregator includes anomaly analysis and event process 39 that use connection table data and flow records to detect anomalies and process anomalies into events that are reported to the operator console or cause the system 10 to take action in the network 18.

Anomalies are detected by examining data in the connection table. The anomalies can be identified as events including denial of service attacks, unauthorized access attempts, scanning attacks, worm propagation, network failures, addition of new hosts, and so forth. Flow records are the main source of data for the connection table discussed below. From the flow records, as further discussed below, long update and short update connection tables for heuristics and so forth are produced. Flow records are also recorded on disk (in flow logs) and used to compute aggregate statistics for reporting and to document network activity over time (for forensic purposes).

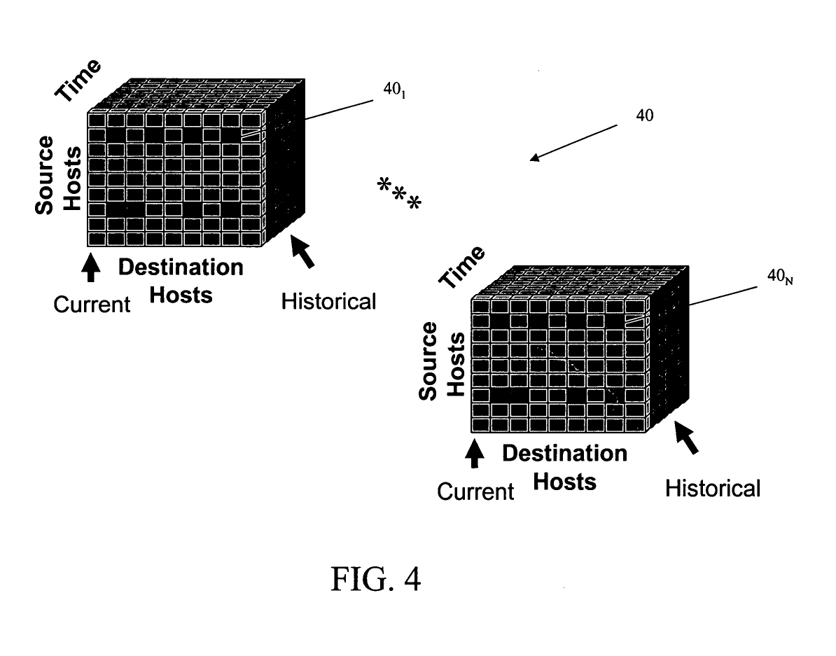

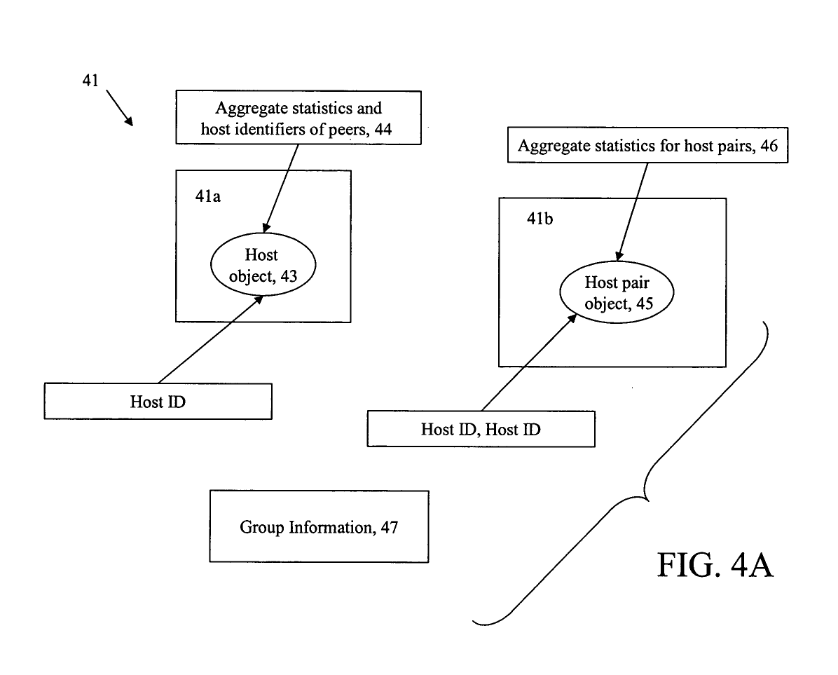

Referring to FIG. 4, the connection table 40 is a series of data structures that map each host (e.g., identified by IP address) to a “host object” that stores information about all traffic to or from that host. In this embodiment of the connection table, the connection table 40 is distributed as multiple units 40₁ to 40_{N} across an N unit stackable aggregator 14. A distribution of flow records is produced for storage in different ones of the connection table. The connection table 40 is organized according to, e.g., a hash of a source address in one dimension, a hash of a destination address in a second dimension and time in a third dimension. The time dimension allows a current record and historical records to be maintained. Details of the stackable aggregator 14 and the connection table partition are discussed below.

Using IP addresses to uniquely identify hosts could be inadequate in environments with Dynamic Host Configuration Protocol (DHCP) assignments. Thus alternatively, the administrator can configure a DHCP server to produce a MAC address to IP address map. The MAC address to IP address map is sent as a flat file to the stackable aggregator 14. Thereafter, when a collector 12 reports an IP address and counter to/from values, the stackable aggregator 14, for each IP address checks in the most recent map. If the IP address is found in the map, then the host is managed by a DHCP server, and the host ID is the host's MAC address, otherwise the Host ID is the host IP address.

The host object, e.g., 40a of a host “A” also maps any host (IP address) “B” with which “A” communicates to a “host pair record” that has information about all the traffic from “A” to “B” and “B” to “A”. This two-level map enables the system 10 to efficiently obtain summary information about one host and about the traffic between any pair of hosts, in either direction.

The connection table 40 uses a hash map from host identifiers (IP or MAC addresses) to “Host” objects, as discussed. Each Host object maintains aggregate traffic statistics for the associated host (“H”), and a hash map (a 2nd level hash map) from host identifiers (IP addresses) of peers of host H (i.e., hosts that host H had communicated with) as “HostPair” objects. Each HostPair object maintains traffic statistics for each pair of hosts (H and H's peer). To allow more efficient analysis, HostPair objects are duplicated across Host objects. For instance, the HostPair “AB” is maintained both in the hash map within Host “A” and in the hash map within Host “B.” Group information is embedded in the connection table, with each Host object storing information about the group that the associated host belonged to. The connection table 40 maintains a list of all groups and their member hosts.

Referring to FIG. 4A, in an alternative implementation 41 of the connection table 40, the connection table 41 is split into two hash maps 41a and 41b, a “host hash” map 41a and a “host pair” hash map 41b. The “host hash” map 41a maps host identifiers (IP or MAC addresses) to new Host objects 43. Each new Host object 43 has the aggregate traffic statistics for the associated host, as well as a list of the host identifiers (IP or MAC addresses) of all the peers of that host 44. The “host pair” hash map 41b maps pairs of host identifiers to Host Pair objects 45 that maintain traffic statistics 46 for pairs of hosts. In this implementation, Host Pair objects 45 need not be duplicated, as discussed above.

For example, if host A and host B communicate, then the host map has a Host object 43 for A that lists B as a peer, the host map has a Host object 43 for B that lists A as a peer, and the host pair map has a Host Pair object 45 for AB. Group information is stored in a separate table 47 that is loaded, saved, and otherwise managed separately from the traffic statistics in the connection table. Group information does not need to be in memory unless it is actually needed.

Factoring out the group information and moving from many hash maps (top level map, plus one 2nd level map per Host object) to just two makes this implementation of the connection table more compact and decreases memory fragmentation, improving aggregator performance and scalability.

In one embodiment, only “internal hosts” (defined based on configurable IP address ranges) are tracked individually, as described above. The aggregator 14 buckets all other (“external”) hosts into a fixed number of bins according to 8-bit or 16-bit CIDR (Classless Inter-domain Routing) prefix. This approach preserves memory and computational resources for monitoring of the internal network 18 but still provides some information about outside traffic. Other arrangements are possible, for instance, bucketing can be turned off if desired, so that each external host is tracked individually.

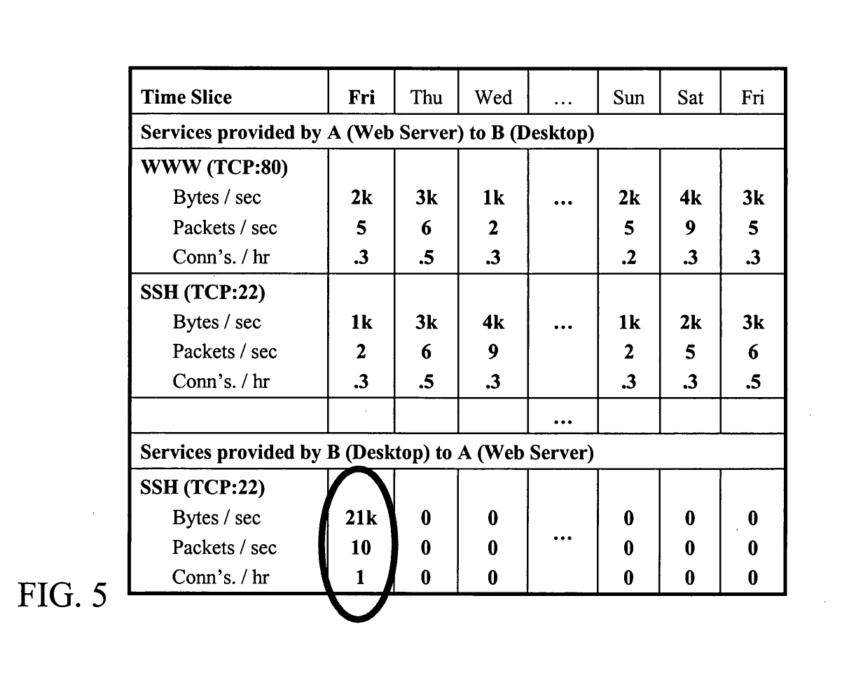

Referring to FIG. 5, exemplary contents of the host object 40a are depicted. Similar statistics can be collected for host objects 43. As shown, the contents of the host object 40a in the connection table 40 include a measure of the number of bytes, packets, and connections that occurred between hosts during a given time-period, here on a daily basis. Data is broken down per-protocol for every well-known transport protocol (e.g., TCP, UDP, ICMP, and the 132 others defined by the “Internet Assigned Numbers Authority” and for several hundred well-known application-level protocols (e.g., SSH, HTTP, DNS, and so forth). For every application-level protocol, and for every pair of hosts “A” and “B”, the Connection Table stores statistics for traffic from host A to host B and from host B to host A both for the case where “A” is the server and the case where “B” is the server. Unknown protocols are counted together.

Since most hosts only use a small fraction of the well-known protocols, the footprint of the data structure is kept manageable by storing protocol-specific records as (protocol, count) key-value pairs. Further, since the protocol distribution is typically skewed (a few protocols account for the majority of traffic on each host), key-value pairs are periodically sorted by frequency to improve amortized update time.

Individual host records have no specific memory limit. If a particular host connects with many other hosts and uses many protocols, all that information will be recorded. However, the total memory used by the aggregator 14 is bounded in order to avoid denial of service attacks on the aggregator 14. For example, an attacker spoofing random addresses can cause the Aggregator 14 to allocate new host structures and quickly consume memory. If an aggregator ever exceeds a memory utilization threshold “m (hi)”, it de-allocates records until its memory utilization falls below “m_{hi}”. Several different algorithms can be used for picking records to de-allocate. Some of the algorithms that can be used include random eviction, picking low-connectivity hosts first, high-connectivity hosts first, and most recently added hosts first. Similar measures are also taken on the probes 12 to ensure high performance and limit Probe-Aggregator communication overhead.

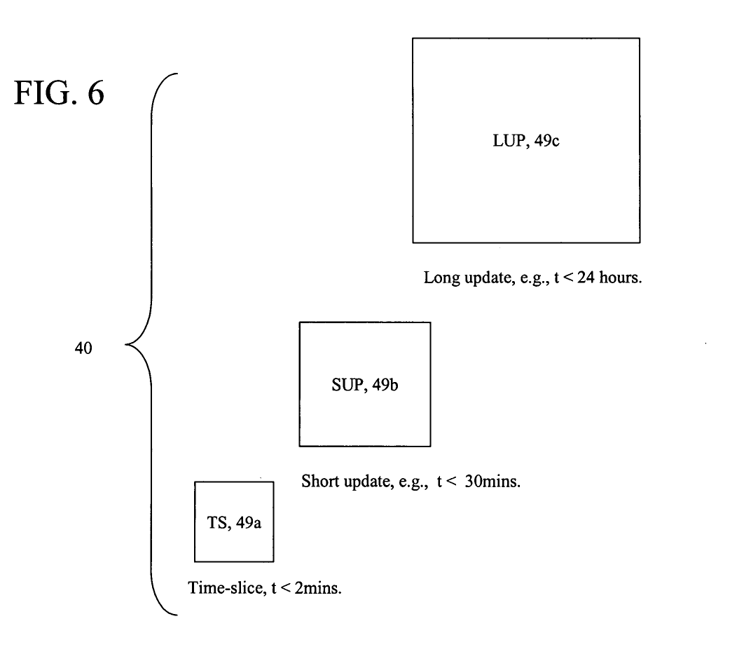

Referring to FIG. 6, the aggregator 14 uses different connection tables 40 to track data at different time scales. A first connection table 49a is a time-slice connection table that operates on the smallest unit of time, e.g., (a time-slice}. A time-slice can be e.g., less than 30 seconds to maybe several minutes. The time-slice connection table is the sum of records received from all collectors during that the time-slice period, corrected for duplicates.

Aggregator analysis algorithms 39 operate primarily on a short update period (SUP) Connection Table 49b, which is the sum of time-slices across a period of, e.g., 10 to 30 minutes. A set of SUP connection tables is summed into a third connection table 49c covering a long update period (LUP), e.g., 2 to 24 hours. For each recorded parameter (such as TCP bytes from host “A” to host “B”), SUP and LUP tables track both the sum and sum of squares of values of the recorded parameter. These two values allow the aggregator to compute both the mean and variance of the recorded parameter across the table's time period. Given “N” samples x1, x2, . . . xn mean is sum over the period of the samples divided by the number of samples. The variance is derived from the mean and sum of squares.

At the end of each long update period, that period's values are merged into a profile connection table that includes historical information for the corresponding period of the week. Merging uses the equation below for each value in the profile table. For instance, a LUP table covering the period 12 pm to 6 pm on a Monday is merged into a profile table with historical information about Mondays 12 pm to 6 pm. Values in the profile table are stored as exponentially weighted moving averages (EWMAs). At time “t”, a new value “xt” (from the LUP table, for example) is added to the EWMA for time “t−1”, denoted by “mt−1”, to generate a new EWMA value according to the following Equation:
mₜ=αxₜ+(1−α)mₜ₋₁

where “l” can be tuned to trade off responsiveness to new values against old values. Exponentially weighted moving averages (EWMAs) provide a concise way of representing historical data (both values and variance) and adapting to gradual trends. Recent data is compared to historical profiles from the same time of, an historical time span, e.g., a week because the week is the longest time span that generally shows well-defined periodicity in traffic patterns. By spanning a week, the approach covers diurnal cycles and week/weekend cycles. Recurring events with longer time periods, for example, monthly payroll operations are less likely to show similarly well-defined patterns.

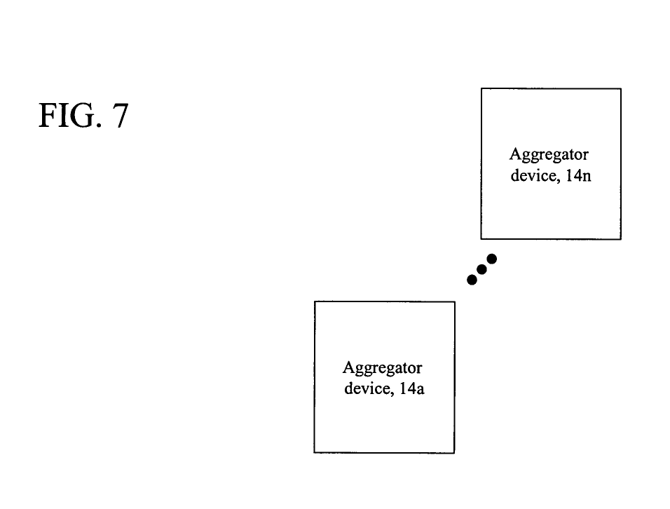

Referring to FIG. 7, the stackable aggregator 14 has the connection table 40 distributed as connection tables 40₁-40_{N} across multiple physical hosts, e.g., multiple physical aggregator devices. The stackable aggregator 14 is configured as a cluster of aggregator devices 14₁-14_{N}, such that the stackable aggregator 14 can grow over time to meet additional processing load requirements. Each host record and its associated host pair records have enough information so that the records can be processed independently by analysis algorithms. Information about different hosts can be dispatched to different aggregator devices 14₁-14_{N}, and identical sets of algorithms can be run on all the aggregator devices 14₁-14_{N}. Individual analysis algorithms can be implemented, as independent threads, in a multiprocessor platform.

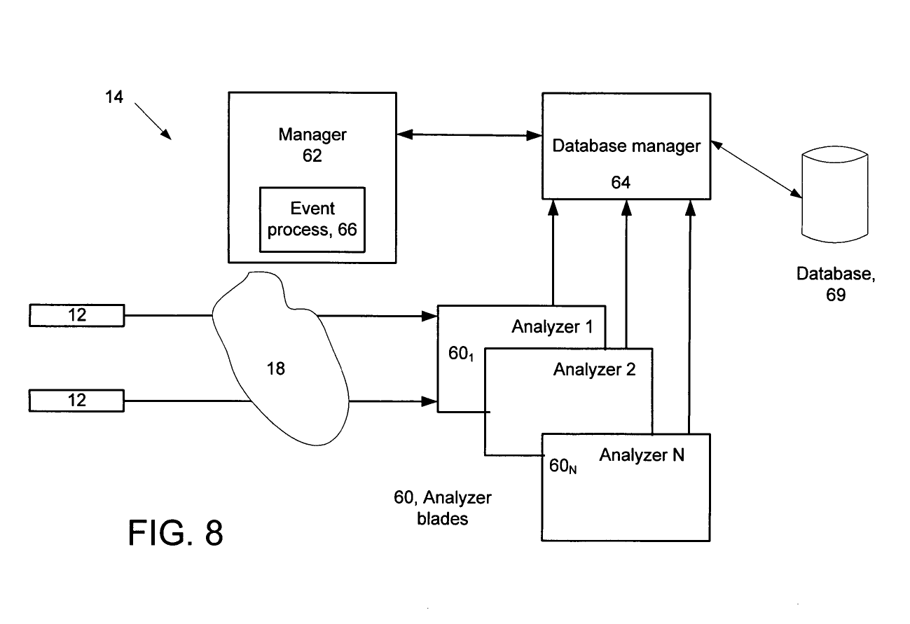

Referring to FIG. 8, an implementation of the stackable aggregator 14 of FIG. 3 is shown. The stackable aggregator 14 distributes storage of network data and execution of security heuristics across two or more hardware devices. One implementation of the stackable aggregator platform 14 is as a blade configuration. The blade configuration includes a mechanical chassis (not shown). The chassis provides power, network connectivity, and various diagnostics for each blade. The blade chassis (not shown) provides power, network connectivity, and some shared resources (e.g., CD-ROM drive) to the blades. The blade center chassis runs management software such as IBM Director Management software.

The stackable aggregator 14 includes a plurality of removable “blades” shown as blades 60₁ to 60_{N}. Each blade 60₁ to 60_{N} is analogous to a traditional rack-mounted server device including multiple processors, e.g., two processors, RAM, and local disk storage. The blades are programmed to provide specific functional tasks discussed below.

The stackable aggregator 14 includes a manager blade 62, a database blade 64, and two or more, e.g., N Analyzer blades 60₁ to 60_{N}, as shown. The manager blade 62 includes an Event Manager process 66 used for correlation and reporting. Each Analyzer blade 60₁ to 60_{N} runs one or more software components, as discussed below. On an N-blade analyzer system, each analyzer blade is responsible for storing and analyzing approximately 1/N of the network data (both connection tables and flow logs).

The manager blade 62 assembles and correlates anomaly/event information from the analyzer blades, 60₁-60_{N} provides user interface functions, e.g., a web-based GUI, and query tools (web-based GUI and command-line). The manager blade 62 handles SNMP traps for event alerts. A browsable SNMP MIB manager blade generates SNMP traps for event alerts and provides a browsable SNMP MIB (Management Information Base) that operators can query via standard SNMP tools.

The Event Manager process 66 receives anomaly/event information from the Analyzer blades 60₁-60_{N}, via MPCP. The event manager process 60 is accessible via a control socket from local host for configuration purposes, stores event information in a database on the database blade 64.

The database blade 64 runs the database 69, e.g., a relational database such as the Postgres Linux based database product. The database 69 stores statistical profiles, events, and all system configuration information (user accounts, heuristics settings, alert thresholds, etc.). Other database products and techniques could also be used.

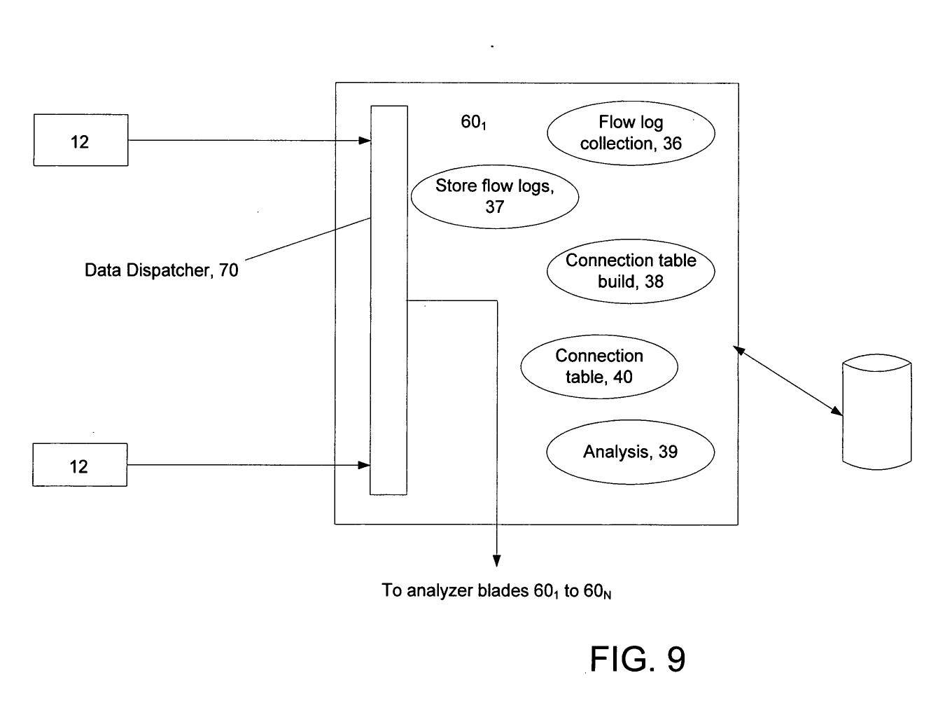

Referring now to FIG. 9, one of the Analyzer blades, e.g., Analyzer_1 60₁ runs a dispatcher process 70. The dispatcher process 70 receives flow records and traffic counters from network sensors including data collectors 12, as well as flow probes and similar devices, discussed above. From these data collectors, flow probes and devices, statistics and/or flow records are produced and forwarded to a specific one of the analyzer blades 60₁ to 60_{N} by the dispatcher process 70. The specific one of the analyzer blades 60₁ to 60_{N} is responsible for populating a corresponding one of the connection tables 40₁ to 40_{N}.

The dispatcher process 70 insures a relatively even distribution of flow records by producing a hash of source and destination host IDs values in the flow record or statistic record. The flow records are thereafter distributed to specific analyzer blades 60₁ to 60_{N} based on the hash (of that record or counter's source and destination host IDs IP or MAC addresses). The dispatcher process 70 forwards the statistic record or flow record to the appropriate one of the Analyzer blades 60₁ to 60_{N}.

ANALYZER BLADE_1 60₁ running the dispatcher process 70 is the entry point of network data into the stackable aggregator 14. As with other analyzer blades 60₂ to 60_{N} discussed below, ANALYZER BLADE_1 is responsible for maintenance and analysis of a fraction (approx 1/N) of the connection table 40, and for storage of a fraction (approx 1/N) of the flow logs.

In a particular implementation of the system, the dispatcher 70 receives flow records via the Mazu Profiler Control Protocol (MPCP) from the collectors 12. The dispatcher 70 receives IP Counters via MPCP from a local Netscout component. The dispatcher 70 is accessible via a control socket from the Manager blade 62 and local host, for configuration purposes. For each flow record and IP Counter, the dispatcher 70 uses a hash function of the host IDs (IP or MAC addresses) to determine which of the Analyzer blades_1-N 60₁ to 60_{N} should maintain that information. The dispatcher 70 forwards the flow records and IP Counters to the Analyzer component on the appropriate analyzer blade 60₁ to 60_{N}, via MPCP.

The hash function maps the host IDs (IP or MAC address) of the source and destination hosts of a flow record or IP counter to an integer between 0 and N−1. If both source and destination hash to the same value, the flow record or counter is sent to the one corresponding Analyzer blade. If the host IDs hash to different values, the data is duplicated and sent to both corresponding Analyzers.

The analyzer 60₁ receives the flow records from the Dispatcher 70 via MPCP. The analyzer 60₁ receives data corresponding to approximately 1/N of the hosts monitor by the N-blade aggregator 14. The analyzer blade 60₁ builds statistical profiles of the network data, compares most recent data to statistical profiles and runs security heuristics. The analyzer 60₁ is accessible via control socket from the Manager blade 62 and a local host for configuration purposes. The analyzer 60₁ stores flow logs to files on a local file system. The analyzer 60₁ supports storage of flow logs on a remote network-attached storage (NAS) appliance. The Analyzer stores profiles in a database on the database blade 64 and sends anomaly/event information to Event process 66 on the Manager blade 62 via MPCP.

Although conceptually the Analyzer can be viewed as one component, the analyzer can include multiple, e.g., two processes, analyzing and profile-updating. After the analyzer 60₁ collects traffic data for the latest instance of a period, e.g., (“long update period”), the analyzer 60₁ uses the data to update the connection table, e.g., to update an exponentially-weighted profile. Inter-process communication occurs, e.g., via Unix signals.

Query tools provide various traffic statistics based on flow records stored in flow logs. Statistics can be broken down by time, by hosts or pairs of hosts, by groups of hosts, by protocols, etc. The query tools can read traffic data from flow logs, write output to a Unix “stdout” routine, e.g., an output routine or to a file.

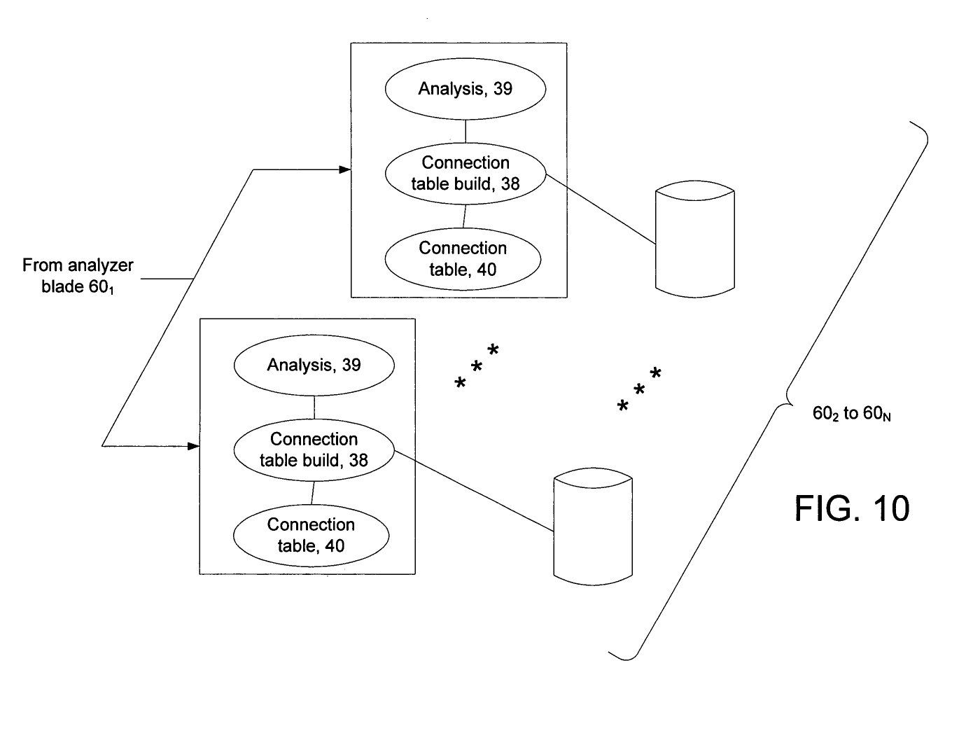

Referring to FIG. 10, remaining analyzer blade(s) 602 to 60_{N} are shown. Each analyzer blade 60₁ to 60_{N} (Analyzer 1 (FIG. 8), and Analyzer 2 through Analyzer N in FIG. 8) produces profiles for its fraction of the network traffic, and runs security heuristics in parallel to all other analyzers. The analyzer blades forward anomalies to the Event Manager process 66 on the Manager blade 62, as the anomalies are generated. The Manager blade 62 runs a user interface, as well as SNMP notification mechanisms, and so forth. The analyzer blades 602 to 60_{N} (Analyzer 2 through Analyzer N) are each responsible for maintenance and analysis of a fraction (approx 1/N) of the connection table, and for storage of a fraction (approx 1/N) of the flow logs.

Each of the analyzer blades 60₂ to 60_{N} (Analyzer 2 through Analyzer N) receives flow records from the dispatcher process 70 in Analyzer 1 60₁ (FIG. 8), via MPCP. The analyzer blades 60₂ to 60_{N} (Analyzer 2 through Analyzer N) each receive data corresponding to approximately 1/N of the hosts monitor by the N-blade aggregator system and builds 38 statistical profiles of network data for its portion of the connection table 40.

The analyzers 60₂ to 60_{N} compare most recent data to profiles and run security heuristics e.g., analysis processes 39. The analyzers 602 to 60_{N} are accessible via a control socket from Manager blade 62 and local host, for configuration purposes. The analyzer 60₂ to 60_{N} stores flow logs to files on its respective local file system 61₂ to 61_{N} and can store flow logs on a remote network-attached storage (NAS) appliance. The analyzer blades store profiles in database 69 on database blade 64, sends anomaly/event information to event manager process 66 on manager blade 62 via MPCP.

As mentioned, Query tools to provide various traffic statistics based on flow records stored in flow logs, as discussed above, can be used. Statistics can be broken down by time, by hosts or pairs of hosts, by groups of hosts, by protocols, etc.

A Query Scheduler periodically (e.g., 30 seconds) checks to see whether it is time to run any user-scheduled queries. Users define scheduled queries via a web-based GUI. Scheduled queries are like interactive queries except that they are configured to occur at predefined times. Scheduling information is stored in the database 69 on the database blade 64. The Queries and results are stored in the local file system (not shown) in the analyzer blade.

The query tools on the Manager blade 62 differ from those on analyzer blades. Whereas query tools on the Analyzer blades 60 read data directly from local flow logs, the query tools on the manager blade 62 connect to Analyzer blades 60 via a secure protocol, e.g., the secure shell protocol (SSH) and invoke the local query tools on each Analyzer 60₁ to 60_{N}. The Analyzer blade queries run in parallel, and their outputs are sent back to the Manager blade over the (SSH) connections and merged by the Manager query tools. The Manager query tools save the merged output to a file that can be used by the manager to generate appropriate reports.

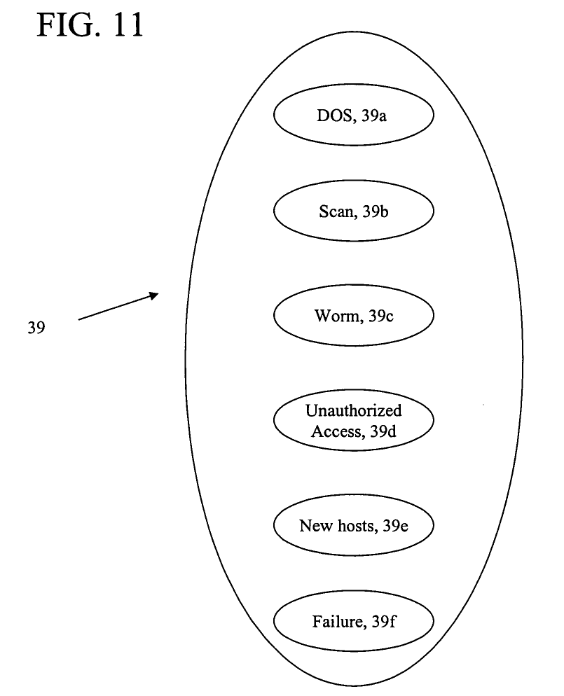

Referring to FIG. 11, the stackable aggregator 14 also includes analysis processes 39 to detect network events. Such processes 39 can include a process 39a to detect bandwidth denial-of-service attacks, a process 39b to detect scanning and probing intrusions, a process 39c to detect worms, a process 39d to detect unauthorized access, a process 39e to detect new hosts on the network, and a process 39f to detect failure of hosts or routers. Other events can also be detected by addition of corresponding processes.

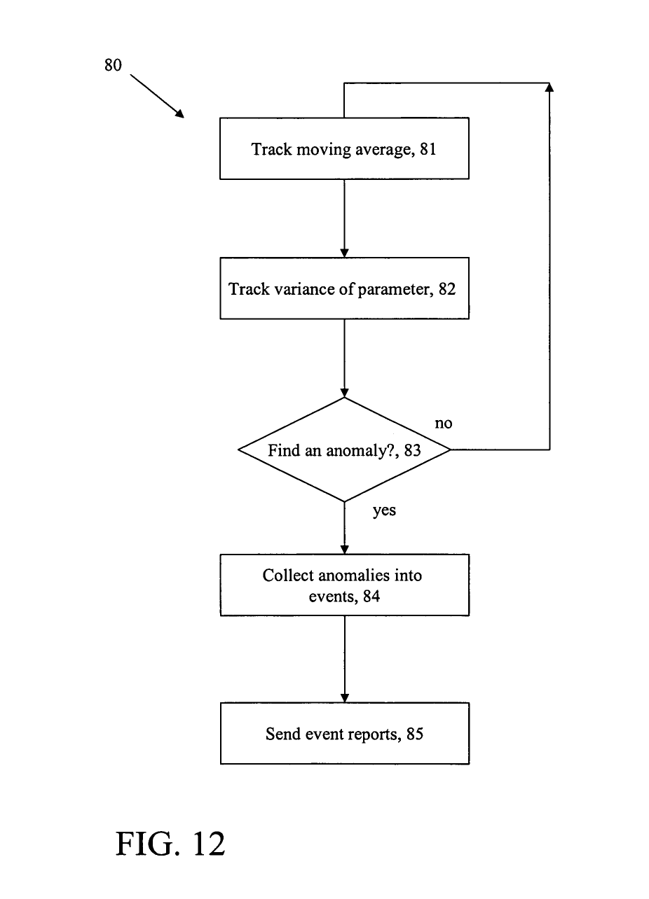

Referring to FIG. 12, a generic flow process 80 of an event detection process is shown. One characteristic of the generic flow process 80 is that, in general, the processes are historical and profile-driven. The generic flow process 80 tracks 81 a moving average that allow processes to adapt to slowly changing network conditions without user intervention. The generic flow process 80 also tracks 82 a variance of a parameter to allow the generic flow process 80 to account for burstiness in network traffic. Several of the algorithms can optionally be tuned via constants to alter parameters such as sensitivity. Historical analysis minimizes the amount of tuning that needs to be done. The benefits of historical analysis, therefore, are to decrease management complexity while improving analysis quality.

The generic flow process 80 operates at two conceptual levels, anomalies and events. The generic flow process 80 finds 83 anomalies, i.e., low-level discrepancies in the network, e.g., a host is receiving unusually high traffic, for example. Conventional intrusion detection would tend to report anomalies directly to the operator. This can be a problem because a single intrusion may correspond to many anomalies, and many anomalies are benign. In contrast, the system 10 using aggregator 14 collects anomalies into events 84. The operator is sent 85 event reports giving the operator more concise and useful information, while simplifying system management.

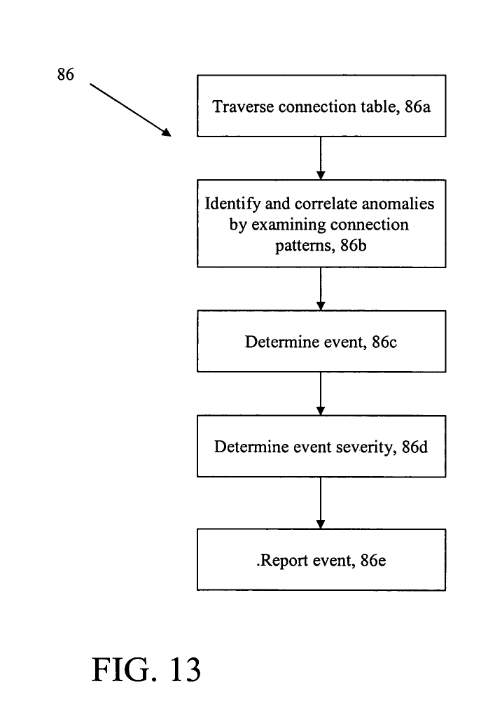

Referring to FIG. 13, processes 39 that handle events, i.e., high-level occurrences that have significance to a network administrator is shown. The processes 39 distinguish among different classes of events. A general flow 86 that can underlie some of the processes 39, discover events by traversing 86a the connection table 40 and identifying 86b and correlating anomalies. From correlated anomalies events are produced 86c. For example, a DoS attack event may be identified because of an abnormal high level of traffic destined to some set of hosts. The generic flow process 80 examines connection patterns rather than packet signatures. Connection patterns can be more strongly correlated with a particular event.

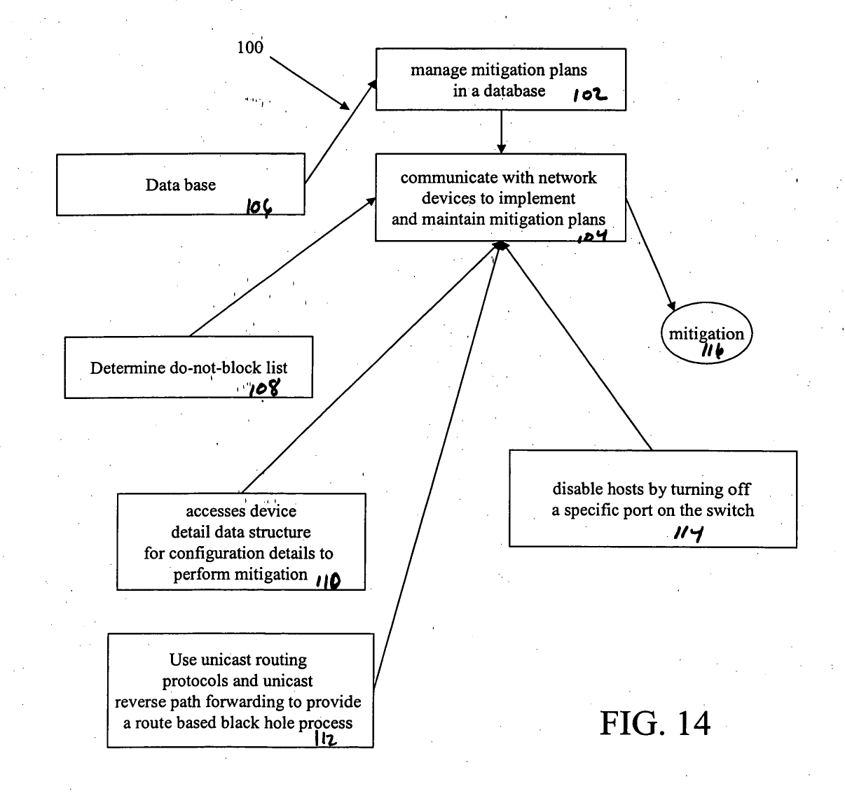

Referring to FIG. 14, the mitigation engine 100 is responsible for producing recommended mitigation plans and managing mitigation plans in, for example, the database 69 (block 102). The mitigation engine 100 is also responsible for communicating with network devices for the purpose of implementing and maintaining mitigation plans (block 104). The mitigation engine 100 generates, manages, and communicates mitigation plans in various ways. For example, the mitigation engine includes a do-not-block list (block 108) that provides a list of hosts or devices which will not be mitigated by the mitigation engine 100. The mitigation engine 100 also accesses detailed information about the configuration of various devices on the network (block 110) in order to determine appropriate mitigation actions and to perform various types of mitigation. The mitigation engine 100 uses various types of mitigation actions dependent on the type of device and circumstances surrounding the mitigation. For example, in some cases the mitigation engine 100 uses unicast routing protocols and unicast reverse path forwarding to provide a route based black hole process (block 112).

In some additional cases, the mitigation engine 100 manages the routing directly by disabling hosts by turning off a particular port or switch (block 114). In some embodiments, the mitigation engine 100 uses the black hole routing 110 and the disabling of hosts 112 concurrently to generate and implement mitigation plans 116.

The mitigation engine 100 includes a collection of C++ classes that manage mitigation related tables in the database 69 and mediate between classes that implement an abstract interface for mitigation devices. The mitigation engine is accessible to the event manager process 66, described above, as well as a web-based user interface. The event manager 66 may simply link directly with the mitigation engine 100, while the web user interface will communicate using a combination of a control socket (as mentioned above) and the database 69. A command line executable is included for testing.

The mitigation engine 100 uses data structures in the generation and management of mitigation plans. Examples of such data structures include an event-id data structure, an event data structure, a do-not-block list, a plan-id data structure, a device detail data structure, a mitigation plan data structure, and a mitigation actions data structure as described below. Additional data structures can be used in addition to the data structures described herein.

The event-id data structure provides a reference to an event in the database. The engine uses the event data as an input parameter for generating mitigation recommendations. Events can be represented as a data structure that includes a detailed account of noteworthy network events. In general, the mitigation engine 100 will read the data included in the event data structure to decide what, if any, mitigation actions to recommend. In order to ensure the accuracy of the data in the event data structure, the mitigation engine 100 does not modify the data stored therein. Based in the event-id data structure and the event data structures, the mitigation engine analyzes events and builds a list of hosts that are misbehaving (e.g., hosts for which mitigation may be appropriate).

Another data structure used by the mitigation engine in the generation and implementation of mitigation plans is the do-not-block list. In general, the do-not-block list includes a collection of hosts and networks expressed as Classless Inter-Domain Routing (CIDR) blocks that are too important to be mitigated. The hosts listed on the do-not-block list are off limits to the mitigation engine 100 when constructing recommended mitigation plans. Thus, the mitigation engine 100 will not automatically mitigate a host that is listed in the do-not-block list. However, hosts in the do-not-block list may be manually mitigated by an operator via a console. Host addresses associated with the System and its sensors will be added to the do-not-block list automatically and marked to indicate that the hosts were added in this manner.

While in the embodiment described above, the do-not-block list is represented using a CIDR addressing scheme which allows for more efficient allocation of IP addresses other addressing schemes are possible. Devices can be added to the do-not-block list in various ways. For example, a web user interface might choose to automatically add hosts involved in active System sessions with sufficient privileges to the do-not-block list. In another example, users can add and remove entries from the do-not-block list.

In order to manage mitigation plans, the mitigation engine 100 includes various information about the devices it manages. Such information is stored in a device detail data structure. The device detail data structure includes a collection of configuration details needed to perform mitigation actions using a specific device. For example, the device detail data structure for an Open Shortest Path First (OSPF) device would have the area ID and authentication details, while the device detail data structure for each switch device would specify an IP address and a set of SNMP community identifiers. Other details may be necessary to add during the design and implementation phases. Devices for receiving mitigation plans can include routers, switches, firewalls, and so forth.

The mitigation engine 100 also includes a data structure for managing mitigation actions. The mitigation actions data structure includes a description of a task to be performed as part of a mitigation plan, including a device and a list of all network nodes that will be directly targeted. An action can be marked as active or inactive, though this value only has immediate force for actions that are part of an active mitigation. All actions in an inactive plan are necessarily inactive. Because a configuration error may make some mitigation actions irreversible, all configuration changes that result from mitigation actions are logged with a timestamp to assist in recovery. Each action will have enough details included to permit the web user interface to calculate a best-effort estimate of the impact if it were enacted, and may include some pre-computed data if this is necessary to permit rapid responses.

The mitigation engine 100 can manage multiple mitigation plans concurrently. These mitigation plans are each referenced by a plan-id data structure. In general, the plan id data structure provides a reference to a stored mitigation plan while the details of the mitigation plan are stored in a mitigation plan data structure.

The mitigation engine also includes a mitigation plan data structure. The mitigation plan data structure includes a collection of mitigation actions to be taken, indexed by a non-empty set of network nodes that will be affected by each action. Separate mitigation plans may call for identical actions. In such cases, the engine ensures that an operation that calls for disabling one when another is still active doesn't take effect on the network, since this would put the mitigation plan database in an inconsistent state. An entire mitigation plan may be disabled, meaning that its effects are undone but it remains present in the database. Disabled mitigation plans may be re-enabled or deleted later. A complete specification of the SQL tables and other structures needed to support the mitigation plans are used. In some cases, a limit on the number and size of the mitigation data structures may be necessary to prevent these from exceeding disk space limitations.

Data associated with active mitigation plans is not modified by code outside of the mitigation engine itself, except perhaps during debugging or diagnostic work. This mainly concerns mitigation plans and actions. Device details are not treated this strictly, so a time-stamped log of changes is required. All code that interacts with device details conforms to this practice. Additionally a warning to a user who attempts to modify a mitigation device that is presently in use may be appropriate.

Interface

The mitigation engine supports various operations that are used to generate and manage mitigation plans. One such operation is a “receive operation.” The receive operation (rec) has the following input(s) and output(s):
input=event-id;
output=plan ticket, reason data;
   This operation produces an inactive mitigation plan intended to reduce the impact of the specified event and returns a ticket for it. The operation receives one or more event ids as an input and based on the event ids generates a plan ticket that includes a plan for mitigating any problems found in the inputted information from the event ids. The operation can also generate reason data which can be viewed by a user in determining whether or not to activate the mitigation plan.

Should the mitigation engine 100 be unable to provide a complete mitigation plan, an attempt is made to give accurate reasons, why a plan was not produced, as part of the output from the mitigation engine. The mitigation engine 100 may not produce a complete recommendation for various reasons. For example, misbehaving hosts may have addresses that are either explicitly on the do-not-block list or are part of subnets in that list. Hosts included on the do-not-block list can not be disabled by a mitigation plan and therefore, if a host on this list is misbehaving the system 10 will not mitigate the action without first removing the host from the do-not-block list. In another example, device specific reasons can prevent a recommendation from being produced.

Another operation supported by the mitigation engine is a “produce operation.” The produce operation has the following input(s) and output(s):
input=list of operations;
output=plan ticket.
   This operation produces an inactive mitigation plan in the database 69 based on a list of actions and returns a ticket for it. An empty list of actions is permitted.

Another operation supported by the mitigation engine 100 is a “do operation.” The “do operation” has the following input(s) and output(s):
input=plan ticket;
output=reason data.

This operation changes a specified mitigation plan from inactive to active (or does nothing if the plan is already active). This operation receives a plan ticket as an input and implements the actions suggested in the mitigation plan. After attempting to implement the actions specified in the mitigation plan, the operation returns reason data. This data includes details about the failure or success of the implementation of the mitigation plan. For example, should one or more devices be unreachable for some reason this will be reported as part of the reason data.

Another operation supported by the mitigation engine is an “undo operation.” The undo operation has the following input(s) and output(s):
input=plan ticket;
output=reason data;
   This operation reverses all actions in a mitigation plan and marks the mitigation plan as inactive. If the mitigation plan specified in the input is already inactive, the undo operation does not change the status of the mitigation plan and the plan remains inactive. The undo operation produces data about the success or failure of undoing the mitigation actions. For example, any failure to reverse an action is reported in the reason data.

Another operation supported by the mitigation engine is a “delete operation.” The delete operation has the following input(s) and output(s):
input=plan ticket;
no output.
   The delete operation is used to remove mitigation plans from the database 69. For example, it can be desirable to remove old mitigation plans that are no longer in use. If the mitigation plan specified in the input is active, the delete operation performs an undo operation to inactivate the mitigation plan prior to removing the mitigation plan from the database. In general, the delete operation removes all data associated with a mitigation plan (other than logs) from the database.

Another operation supported by the mitigation engine is an “edit operation.” The edit operation has the following input(s) and output(s):
input=plan ticket, list of actions to add, list of actions to remove;
output=reason data.
   The edit operation changes the details of a mitigation plan by adding actions, removing actions, or both. In some embodiments, no interface for modifying actions will be provided to keep interaction with the mitigation engine simple. In other embodiments, an interface is provided indirectly by the web user interface to allow a user to edit and make changes in the mitigation plans. Editing an action that is part of an active plan results in communication with devices that are necessary to make the specified changes. Should one or more devices be unreachable a best effort attempt is made to describe what went wrong in the output.

Another operation supported by the mitigation engine is a “status operation.” The status operation has the following input(s) and output(s):
input=mitigation plan;
output=reason data.
   The status operation reports the status of a mitigation plan. The status of a mitigation pan can include whether the mitigation plan is currently active, what actions are associated with the mitigation plan, and/or which actions are active within the mitigation plan.

This interface is intended to be completed for mitigation plans that are not to be directly edited by code outside the mitigation engine. No interface is provided for elements like the do-not-block list which can be edited in the database directly.

Mitigation Operations

Hosts or devices on the network that are misbehaving can be mitigated in various ways. For example, in some embodiments the mitigation engine uses a “black hole process” based on unicast routing protocols to mitigate actions of the host. In some additional embodiments, the mitigation engine manages the routing by turning off a particular port or switch to disable the host.

Device: OSPF Black Hole

Unicast routing protocols such as Open Shortest Path First (OSPF) along with the strict unicast reverse path forwarding (uRPF) feature can be used to implement a route based black hole system. In a route based black hole system, a mitigation host simply acts as a router and advertises a more specific route for misbehaving hosts than is presently available on the network. This route is associated with its null interface. In order to block a single host this would be a route with 255.255.255.255 as a netmask.

Black hole routing is effective for two reasons. Packets sent from the affected host will generally arrive at a router through an interface other than the one expected for traffic from the mitigation host, so strict uRPF causes such traffic to be dropped. Packets sent to the affected host will be routed to the mitigation host, which is configured to send them to its null interface where packets are dropped.

A mitigation host can be the system itself, one or more of its sensors, a special purpose machine, or an existing router of a widely deployed brand and model.

The uRPF feature is enabled on other routers to properly block packets from an affected host. Enabling the uRPF feature may be undesirable in some cases, such when asymmetric routing is needed. Additional problems may be produced by mis-configuring the order in which uRPF and router Access Control List (ACL) protocols are processed. Attempting this method of mitigation without uRPF could fail to mitigate some forms of attack, such as Transmission Control Protocol (TCP) SYN flood attacks. Enabling uRPF at the edge of the network where hosts are connected is generally more desirable than enabling uRPF on internal transit routers. However, detecting that routers are not running uRPF may not be possible. Regardless of mitigation by this method, an affected host will continue to be able to communicate with others on the same network subnet.

A host cannot be completely affected by this form of mitigation if a 255.255.255.255 netmask route to it already exists elsewhere in the routing network. Even advertising the smallest possible cost for the route from the mitigation host will be effective only from parts of the network that are close enough. This case can be detected and reported to the user by examining routing data.

All traffic destined for affected hosts will arrive at the mitigation hosts, possibly overwhelming its network interfaces and routing algorithms. Only a subset of the traffic normally intended for the affected host will arrive, for example because all TCP connections for any purpose will be reduced to a single packet and periodic retries. When traffic from the affected host is effectively mitigated the traffic that reaches the mitigation host will be still less, since only traffic initiated by legitimate hosts will arrive.

Traffic from an affected host will not be dropped if the routing path to the destination host is a subset of the routing path from the mitigation host to the same destination. In this case the network interface on each router the packet reaches will be the same as the one expected if the packet had come from the mitigation host. This means, for example, that a host on the same IP subnet as the mitigation host cannot be affected.

As a technique for partially addressing these issues, using one or more third-party routers each route will be issued by a router selected according to which CIDR block it matches in a user configured table.

Dynamically assigned IPs are not as effectively mitigated since the assignments can change, possibly resulting in an innocent host being blocked. Fortunately, such changes are likely to be infrequent compared to the time needed for a worm to spread, for example.

A malicious host may be able to use mitigation as a denial-of-service tool by spoofing the source address of a victim when misbehaving. The use of strict uRPF should limit this problem to the subnet of the attacker.

Collections of third party packages are supported by routing daemons. The mitigation engine communicates with a daemon for the purpose of injecting routes with 255.255.255.255 for a netmask. Routing table sizes are limited and the system ensures that it does not overwhelm the network with too many routes. A configurable limit on the number of routes advertised is supported.

This mitigation method requires some configuration data. An OSPF area ID, OSPF authentication type, OSPF authentication data, and the maximum route count are among the settings that are made available to the user. All authentication mechanisms supported by commercially available routers, e.g., CISCO routers are supported.

In some cases, device specific reasons that might prevent a recommendation to use black hole routing. For example, the mitigation host might have too many outstanding routes. In another example, another 255.255.255.255 netmask route exists for a mitigated host. In another example, misbehaving hosts may be outside of all areas that can be affected by mitigation devices or may be incompletely affected by source routing due to its position on the network.

Advertising 255.255.255.255 netmask routes may not always be the most effective way to mitigate an event. Routes may be summarized routes to give them a smaller bitmask, resulting in shorter routing tables. Clearly this has implications for impact on legitimate traffic. Protocols other than OSPF such as BGP and RIPv2 can be supported.

Action: Switching

In addition to “black holing” traffic the system provides the ability to disable hosts by turning off a specific port on the switch. The user provides a list of every switch that the user wants to be considered for this form of mitigation. The underlying software to implement “black holing” can be open source and support a large number of switches, including many built by manufacturers. The system will use the data in “SNMP::Info” as the complete repository of what potentially could be mitigated. Also, the user may need to specify additional Layer 3 devices, such as routers, to provide required information about MAC to IP address mappings.

The technical requirements necessary to implement this feature and some of the restrictions include requiring SNMPv1 access to the switches in question. Although forms of access other than SNMP can be used such as telnet or ssh access. For each switch, there is a public and a private community string, for reading settings and toggling ports, respectively. If the private community string is incorrect, an error is reported when an attempt is made to scan the device.

The MAC address to IP address mapping isn't always stored at the switch closest to the machine. Therefore, access to more switches and routers will provide more complete information. When the system recommends a mitigation plan, the system will list the IP address, switch address, and port ID. When mitigation is attempted, success or failure is reported. Useful failure messages will be attempted, but can be limited due to limitations imposed by use of SNMP version 1. The data gathered from the switch is stored in the device, detail data structure. This information will be stored in the database for persistence reasons, but it may be necessary to have a copy in memory for performance reasons.

Because this type of mitigation involves simply turning a port on a switch on and off, there is no significant load placed on the switch as a function of the number of mitigation actions taken. However, the process of gathering information about devices attached to each switch and the requirement to routinely verify that the device information has not changed may be expensive. There are two ways that a user can control this. First, fewer switches can be configured. In addition, each user provides a setting, “scan all switches every N hours.” By setting this to a high number, reduces the load on the system but may reduce the accuracy of the gathered information. After leaving the list and this setting unchanged for N hours, all switches can be considered scanned.

More particularly, if there are M devices, the mitigation engine starts scanning a new device after N*60/M minutes, first waiting for the previous scan to finish. A standalone process does the scanning. If it starts n % of the way through an N-hour period, it will begin scanning at n % of the switch list. If the switch list changes, this process simply restarts and will be synchronized again in N hours.

When given an IP address to mitigate, this component will find the port that cuts off that IP address and the minimum number of other IP addresses. When given multiple IP addresses to mitigate, the above action is performed multiple times, and any duplicate ports are merged.

It is possible that the system will not have a valid recommended mitigation action that involves a switch port (e.g., cannot determine the IP to MAC address mapping or cannot find the switch port that the particular MAC address is associated with). In that case, the user interface will disable any switch based action for that particular host.

The following is a psuedocode representation of a process for querying the various hosts and machines. This process can be used to determine any errors that occur on the devices.

PSEUDOCODE
read list of switches to query
read time_to_scan_switches setting
count = size of switch list
total_time = time_to_scan in seconds
t = time(NULL);
per_device = total_time / count

start_scan = t / total_time * total_time; // when
current scan

would've started

i = (t − start_scan) / count; // a number from 0 to
count−1
next_time = start_scan + (i + 1) * per_device;
while (true) {

for (i; i < count; i++) {

if (time(NULL) >= next_time) {

WARNINGF(“starting %d seconds late”,
time(NULL) −

next_time);

} else {

wait until (time(NULL) = next_time);

}
scan device #i and log errors in database,
in interruptible fashion
next_time += per_device;

} // for i
start_scan += total_time;
next_time = start_scan;
i = 0;

} // while (true)
END PSEUDOCODE

The operation of the pseudo code above assumes that the list of switches and the time_to_scan remains constant during the running of the operation. When the list of switches or time_to_scan changes, the device exits the operation and restarts the above program.

Logging

Some information, such as the commands issued to a mitigation device are best known to the mitigation engine so this component will produce its own log. Mitigation details may end up in other logs as a result of other components. For example, the web user interface is likely to note when user commands relevant to mitigation are issued.

The mitigation engine log will be part of the database 69 so that the web user interface and other parts of the system 10 can easily access it. The log will include a timestamp, the plan-id affected, the event-id if any, a description of what happened, an indication of which devices were affected and what commands were issued. “Passphrase” data, e.g., data used to protect secret keys, will not be logged.

Impact Forecast

An impact forecast will be made by the mitigation engine, which will query the current profile for all hosts targeted by each recommended plan. Any targeted hosts not in the profile (most likely due to sampling) will have impact forecasts generated by querying the flow logs. Number of peers and bytes per second will be the metrics used to measure impact.

The following assumptions relate to a specific design implementation, others of course are possible. More than one OSPF area will be supported if possible. Router coverage will be manually configured or may use the OSPF spanning tree to determine this information, provided an acceptable dynamic solution is found. Use of PostgreSQL data base extensions to standard SQL is acceptable.

A mitigation daemon manages plans. This daemon will have a ControlThread which will be used by external processes. Specifically, the event manager will update a control variable to notify the mitigation daemon of a new or updated event, and the web user interface will use the control socket to activate and deactivate plans. In addition, the mitigation daemon will periodically check that mitigation actions are in consistent state.

Mitigation User Interface

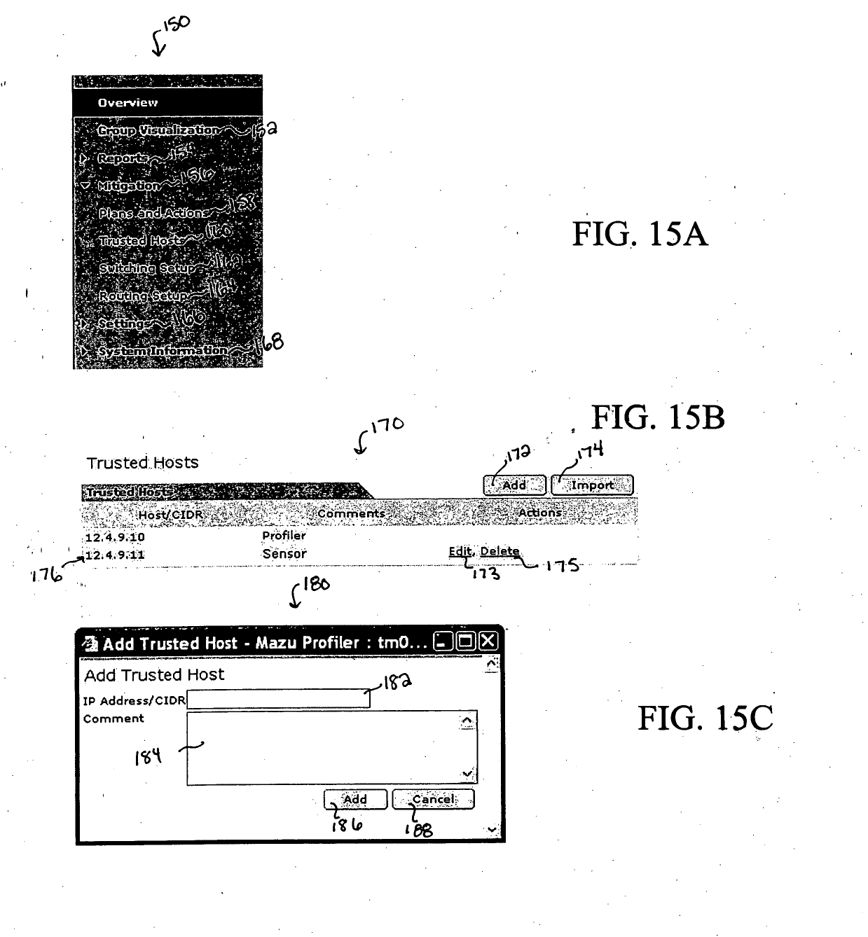

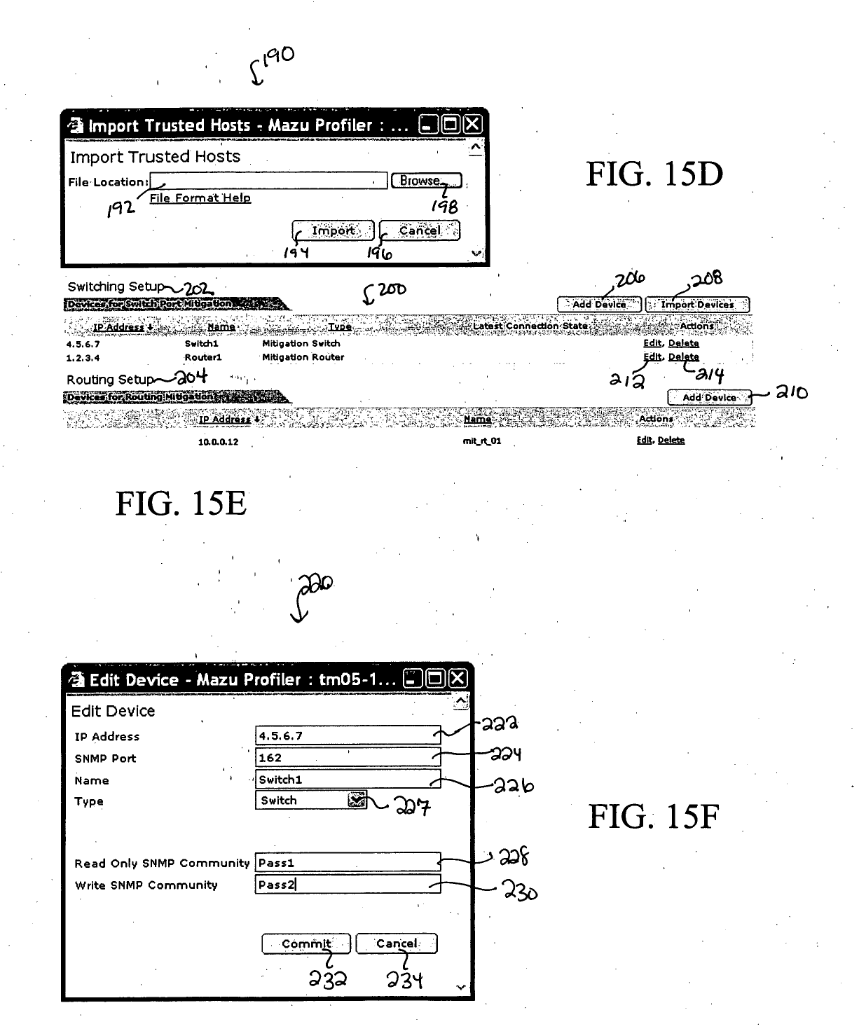

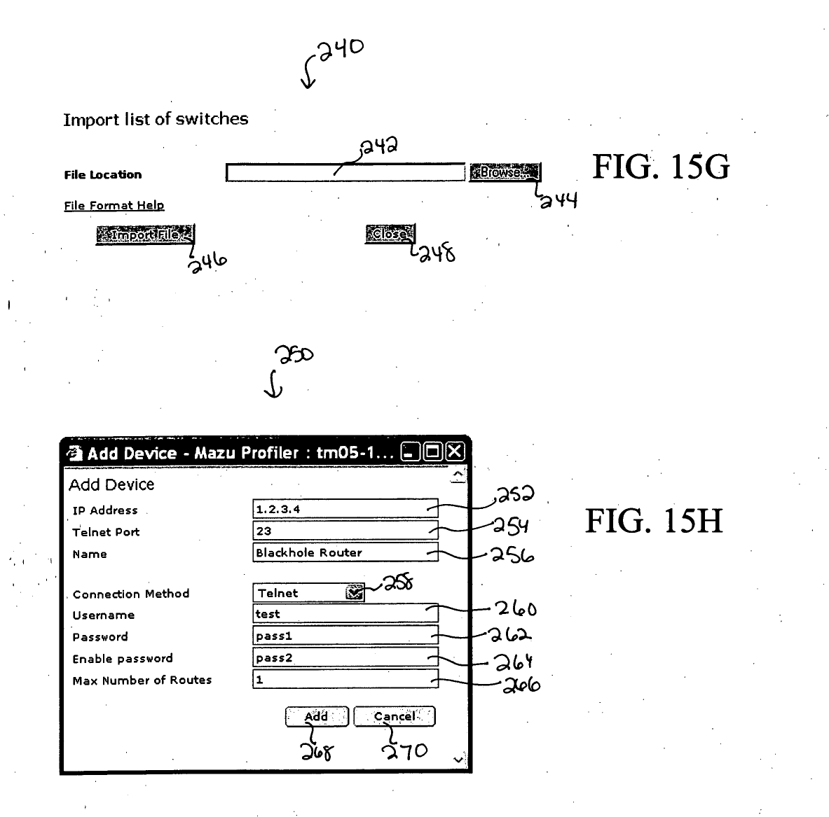

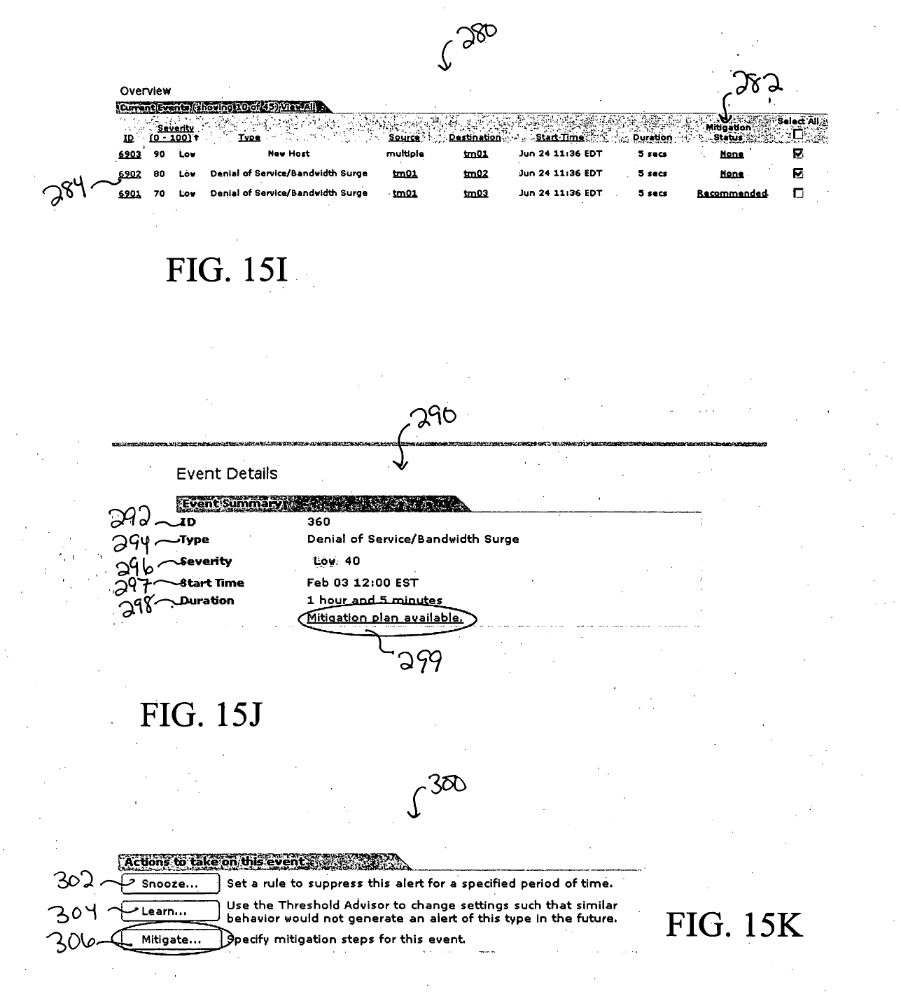

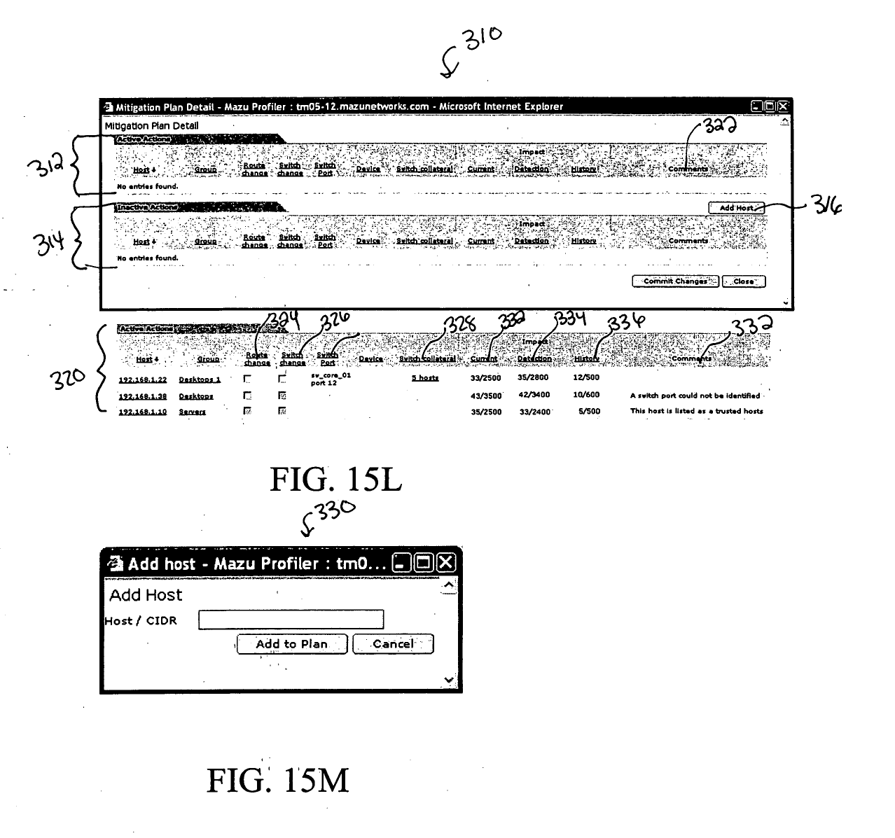

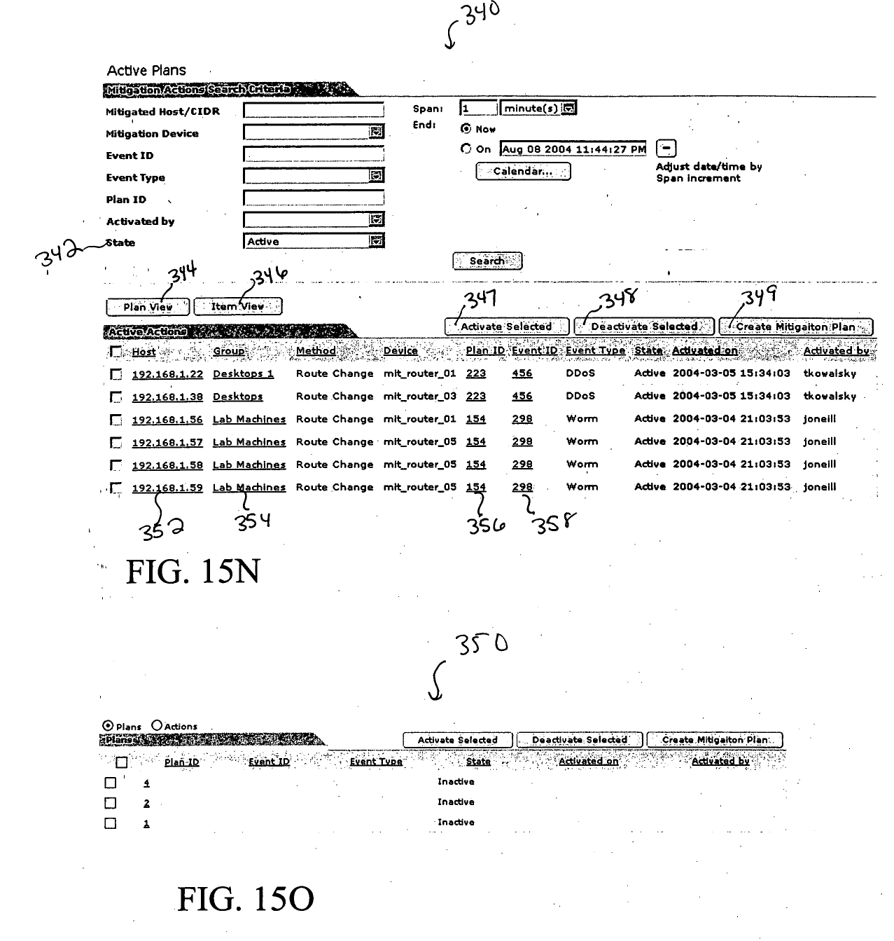

Referring to FIGS. 15A-15O, details of a user interface (UI) for controlling the mitigation features of the mitigation engine 100 are shown. The mitigation UI can be made available in a variety of ways based on a System user interface.

Several activities are performed by a user through the user interface (UI). Those activities include initial configuration, reviewing a mitigation plan, executing a portion or all of that plan, and then undoing the plan once the particular event that generated the plan has ceased to be relevant.

Referring to FIG. 15A, a user interface 150 that provides an overview of the mitigation system and mitigation plans is shown. User interface 150 allows a user to access information by selecting or clicking on a particular link. For example, a user can select a mitigation link 156 to view details about more or more of plans and actions 158, a trusted hosts link 160, a switching setup link 162, and a routing setup link 164. User interface 150 also allows a user to view various settings by selecting the settings link 166 and to view various system information by selecting the system information link 168.

When user desires to view active and/or inactive mitigation plans, the user selects the plans and actions link 158 from the mitigation section 156 of the overview user interface 150. The plans and actions user interface shows any mitigation plans that are currently either recommended or in place. The other settings (Trusted Hosts, Switching Setup, and Routing Setup) are used to configure the Mitigation capability.

Referring to FIG. 15B, a user interface 170 for viewing and adding hosts to a list of trusted hosts is shown. A user can view the list of trusted hosts by selecting the trusted hosts link 160 from the overview user interface 150. Hosts included in the list of trusted hosts list are hosts which are not to be offered or included in mitigation plans. This list of hosts is sometimes referred to as a “white list” or a “do-not-block list”. The hosts included in the trusted hosts list will typically be business critical servers that should not be included in any recommended plan because of the potential for disrupting a critical service.

There are various ways that trusted hosts can be added to the trusted host list. The first is a manual add capability, which allows the user to specify one host at a time. A user can add a host to the trusted hosts list using the manual add capability by selecting add button 172 from the trusted hosts interface 170. As shown in FIG. 15C, selecting the add button 172 directs the user to an add trusted host user interface 180. This user interface 180 includes an input block 182 into which the user can input a selected IP Address or CIDR for a host to be included on the trusted hosts list. The user can also enter any related comments in the comment block 182. For example, these comments can be used to indicate why the host was added to the trusted hosts list or other details that might be useful in reviewing the whether or not to keep the host on the trusted hosts list. After inputting the host name into button 182, a user can cancel add the host to the trusted hosts list by selecting add block 186 or cancel the operation and not add the host by selecting cancel button 188.

As shown in FIG. 15D, another way in which hosts can be added to the trusted hosts list is by importing a list of hosts contained in a file in a format. When a user desires to add hosts by importing a file, the user selects the import button 174 on the trusted hosts user interface 170. Selecting button 174 directs the user to a user interface 190 that includes an input block 192 into which the user can enter a file location for the list of trusted hosts to be imported. The user can also browse a set of files included on the system by selecting the browse button 198. An exemplary file format used to import a list of hosts is a comma separated list of IP addresses and comments (in the order IP_ADDRESS, COMMENT). Each record will be separated by a return. Once the file location has been entered into block 192, the user can add the hosts included in the selected file to the trusted hosts list by selecting import button 194 or can cancel the operation and not add the hosts by selecting cancel button 196.

The mitigation system can also automatically add hosts to the trusted hosts list. For example, the mitigation engine can add a NAS device if one is configured and any configured sensors to this list to protect them from inadvertent mitigation. The System and the NAS device will be identified as “System” resources. This means the user is prevented from deleting or changing the configuration of these devices. This will be enforced through the user interface as the Edit and Delete actions will not be available for these entries. On the other hand, the Sensors can be removed from this list should the user choose to do this.

Referring back to FIGS. 15A and 15B, the trusted hosts user interface 170 also includes an edit link 173. Selecting the edit link 173 brings up the same user interface as the Add button (e.g., user interface 180). However, in the case of Edit the information for the selected row is made available for editing. Thus, block 182 will include the IP address or CIDR for the selected hosts and any previously entered comments will be shown in block 184.

The trusted hosts user interface 170 also includes a delete link 175 that will bring up a confirmation dialog (e.g., Continue, Cancel) for the device being deleted. The delete link 175 allows a user to quickly and easily delete a host from the trusted hosts list.

Referring back to FIG. 15A, a user can select to view and change switching and routing setup by selecting the switching setup link 162 and/or the routing setup link 164. Selecting switching setup link 162 and/or the routing setup link 164 directs a user to a switching setup and routing setup user interface 200 as shown in FIG. 15E. The user can specify one or more mitigation devices through the switching setup and routing setup user interface 200. For routing based mitigation, the device can be any router that supports OSPF and uRPF. For switch based mitigation the device can be a router (i.e., layer three device that provides IP to MAC address mapping information) or any of the supported switches. Also, in the case of Switching, the System will check that the device can actually be reached. If the user selects a router that does not have uRPF enabled, only traffic moving in one direction will be re-routed. The status of the most recent attempt to connect to that particular device will be included in the display for Switching Setup.

The switching setup and routing setup user interface 200 includes an add device button 206 which allows a user to add a single device to the list of devices for switch port mitigation. Selecting the add device button 206 directs a user to an edit device user interface 220 as shown in FIG. 15F. The edit device user interface 220 includes input blocks into which a user can enter the IP address 222, the SNMP port 224, the name 226 and type of the device 227. The name 226 is any text that the user wishes to use to identify that device. The user can also enter whether the device is a read only or write enabled into blocks 228 and 230. Once the user has entered the information for a device the user desires to add to the list, the user selects the commit button 232 to add the device. If the user decides not to add the device, the user can select the cancel button 234 to abort the addition of a new device.

The switching setup and routing setup user interface 200 also includes edit links 212 for the devices included in the lists of devices. Selecting the edit link 212 brings up the same user interface 220 as the Add button 206. However, in the case of Edit the information from the selected rows is made available for editing. User interface 200 also includes a delete link 214 which can be used to remove a selected device from the list. Selecting the delete link 214 presents a confirmation dialog to insure that the user really intends to remove the device.

There are some differences between Routing and Switching Setup. For example, for Switching Setup the user indicates the type of device (router or switch). The only supported connection method is SNMP and the user provides the SNMP Port and two community strings (read-only and write). In addition, an import function is only available in Switching Setup. For the switching setup, an import list of switches user interface 240 (FIG. 15G) allows the user to provide a file containing several devices to be added at once. The format of the import file is as follows:
DEVICE NAME, DEVICE IP, DEVICE TYPE, CONNECTION PORT, READ ONLY COMMUNITY STRING, WRITE COMMUNITY STRING
DEVICE NAME is the name of the device
DEVICE IP is the IP address of the device
DEVICE TYPE is either “SWITCH” for an actionable Switch or “ROUTER” for a lookup router
CONNECTION PORT is the port number to connect to on the device
READ ONLY COMMUNITY STRING is required for reading data from switches and routers
WRITE COMMUNITY STRING is the Community string used for enacting switch port changes

FIG. 15H shows a user interface for adding a device to the list of devices for routing mitigation. For Routing Setup the device type is fixed (i.e., Router only) and the user specifies the connection method 258 (i.e., telnet or ssh). Based on the selection the port 254 will be automatically updated. The user specifies a username 260, read-only password 262, write password 264, as well as the maximum number of routes 266. Not all of this information will be used in all cases.

FIG. 15I shows a current events user interface 280 that provides an overview of the current events for a network. The current events user interface 280 includes a “Mitigation Status” column 282 that displays the mitigation status of a particular event. The mitigation status column 282 can have a status of none, recommended, mitigated, updated, or pending for a particular event. A mitigation status of none indicates that the event is not eligible for mitigation or a mitigation plan cannot be formulated. A mitigation status of recommended indicates that there is a mitigation plan available. A mitigation status of mitigated indicates that the event has an active mitigation plan associated with it. A mitigation status of updated indicates that the event has an active plan which has been updated. A mitigation status of pending indicates that the event does not yet have a mitigation plan.

Plans need not be offered for Sensor Invalid and Sensor Down events. When any mitigation actions are active, the Overview page is updated to indicate the mitigation plans, which are active. When a user selects the mitigation status link provided in the mitigation status column for a particular event, the user is directed to the Active Actions UI 320 (FIG. 15L) so the user can see what actions have been specifically enabled.

Clicking on the Event ID 284 in the Current Events user interface 280 brings up the Event Details user interface 290 (FIG. 15J). The event details user interface 290 includes details about the event such as the event ID 292, the event type 294, the severity 296, the start time 297, and the duration 298.

When a mitigation plan is available for an event, a link 299 will appear on the event summary user interface 290, which will jump to the actions user interface 300 (FIG. 15K) where the “Mitigate” button 306 will be active. The actions user interface 300 also includes a snooze button 302 and a learn button 304.

Clicking the Mitigate button 306 in user interface 300 directs a user to a mitigation plan user interface 310 (FIG. 15L) that includes details about a mitigation plan for that event. The mitigation plan user interface 310 is divided into two sections 312 and 314. Section 312 shows Active Actions (which may be empty if nothing is being mitigated) and section 314 shows Inactive Actions. Inactive Actions are actions that have been proposed but are not yet activated. It is possible for the same recommended action to be Active in one plan and Inactive in another. This plan view will show which hosts can be mitigated via injected route or switch manipulation. In the case that a host cannot be mitigated a reason will be displayed in the comments field 322.

Clicking on Add Host button 316 in user interface 310 will bring up a popup which allows the user to manually add a host of their choosing to the plan. An exemplary add host user interface 330 is shown in FIG. 15M.

In order to mitigate a host the user chooses whether to use a routing change or a switch port for that host. When the user first views the mitigation plan, none of the check boxes for route change 324 or switch change 326 will be checked. The user can select whether to mitigate the host using routing change or a switch port by selecting the appropriate box 324 or 326. In some cases, the user will have the option of mitigating the host using both router and switch based mitigation. If the user checks both boxes 324 and 326, the system will inject the route and attempt to shut off the switch port to which that particular host is attached. In other cases, one or the other form of mitigation may be disallowed. In some cases, no form of mitigation will be available and both check boxes will be disabled. This might happen, for example, if the host is on the Trusted Hosts list.

In cases where multiple hosts are attached to a switch port, the system will indicate how many hosts will be affected if that switch port is disabled (e.g., as shown in Switch Collateral column 328). If the user clicks on the link which indicates how many hosts are affected, the System will display a list of the specific hosts/devices (by IP address if available and by MAC address if not) attached to that switch port.

The mitigation plan detail display is divided into two sections 312 and 314 to make it clear when there are active actions associated with a plan. The top section 312 is labeled Active and the bottom section 314 is labeled Inactive. Only actions that the user has specifically activated will appear in the “Active” section 312. In other words, if the user has decided not to accept one of the recommendations, that action will continue to appear in the “Inactive” section 314 of the plan.

An action ID (sequence number) appears in the display so that the user can view the actions in the order of recommendation. In the case of an ongoing event, this will allow the user to isolate and review the most recent recommendations more easily. (Not shown)

If a host shows up in two plans it will always appear in the “Inactive” section 314 of the second plan even if the identical recommendation (e.g., router based mitigation) happens to be active in another plan. The user can activate the action (again) in the second plan and the mitigation engine will increment the reference count without “reactivating” the action. If the user wishes to disable an action that was activated in more than one plan, user specifically deactivates the action in all plans before it will be undone. The mitigation engine will simply decrement the reference count to zero before undoing the action.

In order to help the user judge the impact of the change, the mitigation plan detail user interface includes three columns 332, 334, and 336 of information intended to show the severity of the ongoing event. The columns are labeled current 332 (updated dynamically to display current data), detection 334, and historical 336. Each column includes a count of host pairs as well as traffic level in packets per second. The Detection column 334 and the historical column 336 are intended to clearly juxtapose normal behavior with the anomalous behavior that caused the event to be triggered. The current column 332 shows up to date information, which may drop to zero if the event is effectively mitigated. The data that is displayed in these columns will be gathered from System data and not from the flow logs. As a result, there is a small possibility that data will not be available to display if the System is in high priority (sampling) mode. In general, historical impact data (displayed in column 336) will come from the appropriate profile and be stored. At time of detection impact data (displayed in column 334) will come from the current_short at the time that the plan was formulated and be stored. Current impact data (displayed in column 332) will be calculated from the current current_short and be continuously updated while either the event is ongoing or the plan is active. The time stamp above the display will indicate when the current data was last updated (not shown)

If the user views a historical event (i.e., an event which is no longer ongoing) for which there are no active plans, will see “stale” information for that event. In this case, the time stamp shown will reflect the last update of the data.

User interface 310 also includes a comments column 322 to inform the user as to why a particular form of mitigation is not available for that host. If there is no problem mitigating that host, then the column will be empty.

The button at the bottom of the screen labeled “Activate Plan” changes to “Update Plan” if the user has already activated the plan and visits this window again. Clicking on this button will bring up a confirmation dialog which requires the user to enter in their login password. This additional security measure confirms that the user performing the mitigation action is authorized to take that action. The user will also be presented with a Notes field, where can choose to enter any comments or notes about the mitigation. This information will be saved in the logs. The password/notes prompt will also appear when the user attempts to undo a plan/action. If the user clicks the Close button, all of their changes are lost with the exception that anything that was manually added (i.e., using the Add Host button) will be saved with the plan (but not activated).

A small dialog will be displayed notifying the user that the transaction has been committed. There is no (currently discovered) way to determine whether the changes have taken effect or whether the changes have failed. The only indication of failure would be if communicating with a switch failed in some obvious way.

All changes will be logged as user, client IP, event id, target IP Address, Device Type, Device IP, Action taken and Notes.

Referring to FIG. 15N, an Active Plans user interface 340 allows the user to view all actions and filter them by many criteria including state 342. By default this page will initially show all actions which are currently active (e.g., it will come up in Item View with the search criteria set for active actions).

The Plan View button 344 and Item View button 346 are place holders for a toggle function which will change stated based on the current view. The Item (Actions) view (shown in FIG. 15N) displays all information for each action while the plan view (shown in FIG. 15O) will only show a summary of each plan. If there are a large number of plans and/or actions in effect, the user can use the search criteria at the top of the page to refine the list being displayed. For example, all hosts mitigated through a particular switch could be selected or all actions initiated by a particular user can be examined. Users can view both currently active actions/plans and actions that were initiated in the past that are no longer active. The Activate Selected button 347 will activate selected actions whose state is “Inactive”. If an action is already activated, pressing the activate selected button 347 will have no effect. Deactivate Selected button 348 will deactivate selected actions whose state is “Active”. If an action is already deactivated, pressing the deactivate selected button 348 this will have no effect.

Pressing the Produce Mitigation Plan button 349 will bring up an empty mitigation plan to which the user can add hosts. Trusted Hosts will not be allowed to be mitigated.

The user interface 340 also includes links that will take the user to the appropriate details for the particular item selected. Clicking an IP address 352 will display the top services for that particular host. Clicking a group name 354 will display the top services for that group. Choosing a plan ID 356 will show the actions associated with that plan (see display below). Choosing an event ID 358 will display the event details.

A number of embodiments of the invention have been described. Nevertheless, it will be understood that various modifications may be made without departing from the spirit and scope of the invention.

What is claimed is:

1. A computer program product residing on a computer readable medium for producing recommended mitigation plans to mitigate intrusions in a networked system, the program comprising instructions for causing a processor to:
manage mitigation plans stored in a database; and
communicate with network devices on the network system to implement and maintain the mitigation plans.

2. The computer program product of claim 1 wherein instructions to manage include instructions to manage mitigation related tables in the database.

3. The computer program product of claim 2 wherein instructions to manage include a collection of C++ classes that mediate between classes that implement an abstract interface for mitigation devices.

4. The computer program product of claim 1 wherein instructions to manage include instructions to analyze events and build a list of hosts that are misbehaving.

5. The computer program product of claim 1 wherein the computer program product accesses a do-not-block list, which is a collection of hosts and networks expressed as Classless Inter-domain Routing (CIDR) blocks that are too important to be mitigated, which collection are not automatically mitigated.

6. The computer program product of claim 1 wherein the computer program product accesses a device detail data structure that is a collection of configuration details needed to perform mitigation actions using a specific device.

7. The computer program product of claim 1 wherein the computer program product accesses a mitigation actions data structure which is a description of a task to be performed as part of a mitigation plan, including a device and a list of all network nodes that will be directly targeted.

8. The computer program product of claim 1 wherein the computer program product accesses a mitigation plan data structure, which is a collection of actions to be taken, indexed by a non-empty set of network nodes that will be affected by each action.

9. The computer program product of claim 1 wherein the computer program product, wherein data associated with active mitigation plans is not modified by any code outside of the mitigation engine.

10. A computer program product for an intrusion detection system to produce recommended mitigation plans, comprises instructions for causing a processor to:
use unicast routing and unicast reverse path forwarding protocols to provide a route based black hole process to advertise a more specific route for misbehaving hosts than available on the network, associated with its null interface.

11. The computer program product of claim 10 wherein unicast reverse path forwarding causes packets to be dropped if the packets were sent from an affected host, and the packets arrive at a router through an interface other than the interface expected for the traffic.

12. The computer program product of claim 10 wherein the computer program product, causes packets sent to the affected host to be routed to the mitigation host, which is configured to send the packets to its null interface where packets are dropped.

13. A computer program product residing on a computer readable medium for producing recommended mitigation plans to mitigate intrusions in a networked system, the program comprising instructions for causing a processor to: disable hosts by turning off a specific port on the switch based on a list of every switch that the user wants to be considered for disabling hosts by turning off a specific port.

14. The computer program product of claim 13 wherein the computer program product, gathers data from switches in the list.

15. The computer program product of claim 13 wherein the computer program product, includes instructions to gathers data from switches in the list.

16. The computer program product of claim 13 wherein the instructions to gather data from switches in the list includes instructions to:
periodically verify that the device information has not changed.

17. A mitigation plan detail interface comprises:
a first section for listing active mitigation plans, which are actions that the user has specifically activated;
a second section for listing inactive mitigation plans, which are actions that the user has decided not to accept.

18. The interface of claim 17, wherein an action ID (sequence number) appears in the interface so that the user can view the actions in the order of recommendation.

19. The interface of claim 17, wherein the interface includes three columns of information to depict a severity of an ongoing event, a first column is updated dynamically to display current data second column “detection” displays data at the time of detection and “Historical,” which displays historical data pertaining to the host and with each column including a count of host pairs as well as traffic level.

20. The interface of claim 19, wherein the detection column and the historical column are juxtaposed each other to clearly delineate normal behavior and anomalous behavior that caused the event to be triggered.

21. The interface of claim 19, wherein the current column shows up to date information that changes according to changes in the event, and which will drop to zero if the event is effectively mitigated.

22. A system, comprising:
a plurality of collector devices disposed to collect statistical information on packets sent between nodes on a network;
a stackable aggregator device that receives network data from the plurality of collector devices, the aggregator device producing a connection table that maps each node on the network to a record that stores information about traffic to or from the node, the stackable aggregator comprising:
a manager blade,
a database blade, and
two or more, analyzer blades and wherein each blade includes a mitigation engine to manage mitigation plans stored in a database and to communicate with network devices to implement and maintain mitigation plans.

23. A computer program product for minimizing effects of configuration errors or accidental bad mitigation plans in a intrusion detection system, comprises instructions to:
manage mitigation plans in a database;
communicate with network devices to implement and maintain mitigation plans; and
log all configuration changes to the network devices by a time stamp in order to undo mitigation plan based changes to recover from a configuration error resulting from a mitigation action.
